(19) United States
(12) Patent Application Publication
(10) Pub. No.: US 2008/0055271 A1
(43) Pub. Date: Mar. 6, 2008

(54) DISPLAY SYSTEM, DISPLAY METHOD, AND DISPLAY PROGRAM

(75) Inventors: Hiroshi Yamaguchi, Ashigarakami-gun (JP); Shuji Ono, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/849,915

(22) Filed: Sep. 4, 2007

(30) Foreign Application Priority Data
Sep. 4, 2006 (JP) 2006-239424
May 29, 2007 (JP) 2007-142488

(51) Int. Cl. G06F 3/041

(52) U.S. Cl. 345/173

(57) ABSTRACT

A display system according to the present invention includes: a plurality of pieces of electronic paper, each of which includes a display section that displays data and a light quantity detection section that detects an irradiated light quantity; a positional relation determination section that determines a mutual positional relation of the plurality of pieces of electronic paper, from the light quantity detected by the light quantity detection section included in each of the plurality of pieces of electronic paper; and a data transmission section that transmits data to be displayed to the display section included in each of the plurality of pieces of electronic papers to each of the plurality of pieces of electronic paper, in accordance with the mutual positional relation of the plurality of pieces of electronic paper determined by the positional relation determination section.

### CROSS REFERENCE TO RELATED APPLICATION

The present application claims priority from Japanese Patent Applications No. 2006-239424 filed on Sep. 4, 2006 and No. 2007-142488 filed on May 29, 2007, the contents of which are incorporated herein by reference.

### BACKGROUND

1. Technical Field

The present invention relates to a display system, a display method, and a display program. In particular, the present invention relates to a display system, a display method, and a display program for displaying data to electronic paper by determining a positional relation among a plurality of pieces of electronic paper.

2. Related Art

A power supply apparatus, in which a device at the reception side (e.g. PDA) is placed at an arbitrary place of a power feeder apparatus provided with a plurality of power feeder coils to supply power from the power feeder coils to the device at the power reception side in a noncontact manner, has been proposed (e.g. Patent Document 1). Concretely, the power feeder apparatus supplies power by performing sequential selection among the plurality of power feeding coils. Then the power reception coil at the power reception device generates an induction power upon reception of an electromagnetic wave generated by the power feeder coils. Subsequently, the power reception device uses the generated induction power to transmit an ID of the power reception device to the power feeder apparatus. In response, the power feeder apparatus confirms the position of the power reception device, and supplies power thereto.

Moreover a noncontact charging system is proposed in which a mobile telephone is installed on a charging sheet equipped with a plurality of primary coils, and a transmission frequency of the primary coils is automatically set according to the specification of the installed mobile telephone (e.g. Patent Document 2). Concretely, the frequency of the alternating voltage to be supplied to the primary coils is gradually increased, and the transmission frequency is fixed when the mobile telephone has started to be charged.
[Patent Document 1] Japanese Unexamined Patent Application Publication No. 2003-224937
[Patent Document 2] Japanese Unexamined Patent Application Publication No. 2005-6440

### SUMMARY

However, according to the inventions in Patent Document 1 and Patent Document 2, it is sometimes difficult to determine to which power reception device power should be fed, when there are a plurality of devices at the reception side. Moreover, according to the inventions in Patent Document 1 and Patent Document 2, also when a plurality of devices at the reception side are overlapped with each other, it sometimes poses difficulty in determining to which power reception device power should be fed.

In view of this, it is an object of one aspect of the present invention to provide a display system, a display method, and a display program that are capable of solving the foregoing problems. This object is achieved by combinations of features described in the independent claims. The dependent claims define further advantageous and concrete examples of the present invention.

According to the first aspect related to the innovations herein, one exemplary display system includes: a plurality of pieces of electronic paper, each of which includes a display section that displays data and a positional information detection section that detects positional information for determining a positional relation; a positional relation determination section that determines a mutual positional relation of the plurality of pieces of electronic paper, from the positional information detected by the positional information detection section included in each of the plurality of pieces of electronic paper; and a data transmission section that transmits data to be displayed to the display section included in each of the plurality of pieces of electronic paper, to each of the plurality of pieces of electronic paper, in accordance with the mutual positional relation of the plurality of pieces of electronic paper determined by the positional relation determination section.

According to another aspect related to the innovations herein, one exemplary apparatus includes: a plurality of pieces of electronic paper, each of which includes a display section that displays data and an electromagnetic wave strength detection section that detects a strength of an irradiated electromagnetic wave; a positional relation determination section that determines a mutual positional relation of the plurality of pieces of electronic paper, from the strength detected by the electromagnetic wave strength detection section included in each of the plurality of pieces of electronic paper; and a data transmission section that transmits data to be displayed to the display section included in each of the plurality of pieces of electronic paper, to each of the plurality of pieces of electronic paper, in accordance with the mutual positional relation of the plurality of pieces of electronic paper determined by the positional relation determination section.

It is also possible to arrange so that the positional relation determination section determines that the plurality of pieces of electronic paper are overlapped to each other in an order of the strength detected by the electromagnetic wave strength detection section included in each of the plurality of pieces of electronic paper, and the data transmission section transmits the data to be displayed to the display section included in each of the plurality of pieces of electronic paper, to each of the plurality of pieces of electronic paper, in an order in which the plurality of pieces of electronic paper are overlapped to each other determined by the positional relation determination section. Moreover, it is also possible to arrange so that the positional relation determination section detects that the electronic paper including the electromagnetic wave strength detection section having detected a predetermined strength or more exists in a position visible to a user, and the data transmission section, to the electronic paper which the positional relation determination section has determined to exist in a position visible to the user, transmits the data to be displayed to the display section included in the electronic paper.

It is also possible to arrange so that the positional relation determination section determines that the electronic paper including the electromagnetic wave strength detection section having detected a predetermined strength or more exists in a position visible to a user, and the display system further includes: a data editing control section that permits editing of contents of data on display by the display section included in the electronic paper which the positional relation determination section has determined to exist in a position visible to the user. Moreover, it is also possible to arrange so that the positional relation determination section determines that the electronic paper including the electromagnetic wave strength detection section having detected the largest strength exists in a position visible to a user, and the data transmission section, to the electronic paper which the positional relation determination section has determined to exist in a position visible to the user, transmits the data to be displayed to the display section included in the electronic paper.

In addition, it is also possible to arrange so that the positional relation determination section determines that the electronic paper including the electromagnetic wave strength detection section having detected the largest strength exists in a position visible to a user, and the display system further includes: a data editing control section that permits editing of contents of data on display by the display section included in the electronic paper which the positional relation determination section has determined to exist in a position visible to the user. Moreover, it is also possible to arrange so that the electronic paper further includes a data identifier storage section that stores a data identifier identifying data on display by the display section, the display system further includes a display order storage section that stores, in association with each of a plurality of data identifiers, a display order of data identified by the data identifiers, the positional relation detection section determines that the plurality of pieces of electronic paper are overlapped to each other, in an order of the strength detected by the electromagnetic wave strength detection section included in each of the plurality of pieces of electronic paper, and the data transmission section transmits each data identified by a data identifier stored in any of a plurality of the data identifier storage section, to each of the plurality of pieces of electronic paper, so as to match the display order of data stored in the display order storage section and the order in which the plurality of pieces of electronic paper are overlapped to each other determined by the positional relation determination section.

In addition, it is also possible to arrange so that the electromagnetic wave strength detection section includes a plurality of electromagnetic wave detection sensors respectively placed at a plurality of predetermined positions of the electronic paper, and the positional relation determination section determines the mutual positional relation of the plurality of pieces of electronic paper, from strengths of electromagnetic waves respectively detected by the plurality of electromagnetic wave detection sensors included in each of the plurality of pieces of electronic paper. Moreover, it is also possible to arrange so that the plurality of electromagnetic wave detection sensors are placed in respective vicinities of a plurality of sides or a plurality of corners of the electronic paper. It is also possible to arrange so that the positional relation determination section determines that the plurality of pieces of electromagnetic wave overlapped to each other, in an order from electronic paper having more electromagnetic, detection sensors in number having detected a electromagnetic wave strength of a predetermined value or more, from among the plurality of electromagnetic wave detection sensors included in each of the plurality of pieces of electronic paper. Furthermore, it is also possible to arrange so that a power feeder apparatus that feeds power to the electronic paper by generating a magnetic field in a predetermined range, where the electronic paper further includes a power reception section that receives power from the magnetic field generated by the power feeder apparatus, and when the power reception section has received power, the electromagnetic wave strength detection section detects the strength of the magnetic wave using the received power.

In addition, it is also possible to arrange so that the positional relation determination section determines that the electronic paper including the electromagnetic wave strength detection section having detected a predetermined strength or more exists in a position visible to a user, the display system further includes: a position identifying section that identifies a position of the electronic paper which the positional relation determination section has determined to exist in a position visible to the user, and the power feeder apparatus includes: a plurality of power feeder sections placed in a predetermine interval therebetween in a range where the electronic paper is to be positioned; and a power feeder control section that generates a magnetic field to power feeder sections positioned in the position identified by the position identifying section and causes to feed power to the electronic paper which the positional relation determination section has determined to exist in a position visible to a user. It is also possible to arrange so that the positional relation determination section determines that the electronic paper including the electromagnetic wave strength detection section having detected the largest strength exists in a position visible to a user, the display system further includes a position identifying section that identifies a position of the electronic paper which the positional relation determination section has determined to exist in a position visible to the user, and the power feeder apparatus includes: a plurality of power feeder sections placed in a predetermined interval therebetween in a range where the electronic paper is to be positioned; and a power feeder control section that generates a magnetic field to power feeder sections positioned in the position identified by the position identifying section and causes to feed power to the electronic paper which the positional relation determination section has determined to exist in a position visible to a user.

According to another aspect related to the innovations herein, one exemplary display method includes: a displaying step of displaying each data by a display section included in each of a plurality of pieces of electronic paper; an electromagnetic wave strength detecting step of detecting a strength of an electromagnetic wave strength irradiated on the plurality of pieces of electronic paper; a positional relation determining step of determining a mutual positional relation of the plurality of pieces of electronic paper, from the strength detected for each of the plurality of pieces of electronic paper in the electromagnetic wave strength detecting step; and a data transmitting step of transmitting data to be displayed to the display section included in each of the plurality of pieces of electronic paper, to each of the plurality of pieces of electronic paper, in accordance with the mutual positional relation of the plurality of pieces of electronic paper determined in the positional relation determining step.

According to the third aspect related to the innovations herein, one exemplary display program is for a display system that includes a plurality of pieces of electronic paper that displays data, the display program causing the display system to function as: an electromagnetic wave strength detection section that detects a strength of an electromagnetic, wave irradiated on the plurality of pieces of electronic paper; a positional relation determination section that determines a mutual positional relation of the plurality of pieces of electronic paper, from the strength detected by the electromagnetic wave strength detection section included in each of the plurality of pieces of electronic paper; and a data transmission section that transmits data to be displayed to the display section included in each of the plurality of pieces of electronic paper, to each of the plurality of pieces of electronic paper, in accordance with the mutual positional relation of the plurality of pieces of electronic paper determined by the positional relation determination section.

The summary clause does not necessarily describe all necessary features of the embodiments of the present invention. The present invention may also be a sub-combination of the features described above.

According to an aspect of the present invention, it becomes possible to determine a piece of electronic paper from among a plurality of pieces of electronic paper, which is visible to a user, by determining a mutual positional relation of the plurality of pieces of electronic paper.

### BRIEF DESCRIPTION OF THE DRAWINGS

FIG. 1 shows an overview of a display system 10.

FIG. 2 is a block diagram showing a functional configuration of electronic paper 20 and a power feeder apparatus 40.

FIG. 3 is a block diagram showing a functional configuration of an information processing apparatus 30.

FIG. 4 shows a placement of a light sensor 252 included in a light quantity detection section 250.

FIG. 5 shows an operation of the display system 10.

FIG. 6 shows the power feeder apparatus 40.

FIG. 7 shows another example of the display system.

FIG. 8 shows one example of electronic paper 60.

FIG. 9 shows a display example in the present display system.

FIG. 10 shows another display example in the present display system.

FIG. 11 shows another display example in the present display system.

FIG. 12 shows another display example in the present display system.

FIG. 13 shows another display example in the present display system.

FIG. 14 shows another display example in the present display system.

FIG. 15 shows another display example in the present display system.

FIG. 16 shows another example of a functional configuration of the electronic paper 20 and the power feeder apparatus 40.

FIG. 17 shows a partial cross-sectional view of the electronic paper 20.

FIG. 18 is a block diagram showing a hardware configuration of the display system 10.

### DESCRIPTION OF EXEMPLARY EMBODIMENTS

Some aspects of the invention will now be described based on the embodiments, which do not intend to limit the scope of the present invention, but exemplify the invention. All of the features and the combinations thereof described in the embodiment are not necessarily essential to the invention.

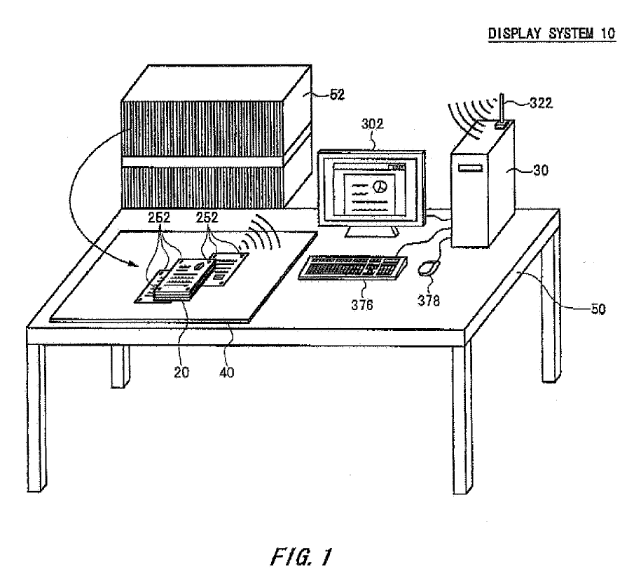

FIG. 1 shows an overview of a display system 10 according to one embodiment of the present invention. The display system 10 includes electronic paper 20, an information processing apparatus 30, and a power feeder apparatus 40. Note that the display system 10 may include a plurality of pieces of electronic paper 20. In addition, the information processing apparatus 30 includes a monitor 302 for displaying data, and a keyboard 376 and a mouse 378 allowing a user to, when changing the contents of data, input the change contents of data. Note that to electronic paper 20 may be a flexible display, rewritable paper, a paper-like display, digital paper, electronic paper, an electronic sheet and an electronic display sheet.

The display system 10 according to the present embodiment determines a mutual positional relation of the plurality of pieces of electronic paper, based on the strength of an electromagnetic wave irradiated onto the pieces of electronic paper. The display system 10 aims to identify electronic paper visible to the user, according to the mutual positional relation of the pieces of electronic paper, and to display data to be displayed to the electronic paper.

For example, the plurality of pieces of electronic paper 20 for displaying data are stored in a bookshelf 52. A user takes out electronic paper 20 from the bookshelf 52 and places the electronic paper 20 on the power feeder apparatus 40 placed on a desk 50. The user may place several pieces of electronic paper 20 in a bundle on the power feeder apparatus 40. In addition, a user may place several pieces of electronic paper 20 in an overlapping state on the power feeder apparatus 40. The power feeder apparatus 40 supplies power to each of the plurality of pieces of electronic paper 20.

Here, each of the plurality of pieces of electronic paper 20 has a plurality of light sensors 252. Note that the plurality of light sensors 252 included in each of the plurality of pieces of electronic paper 20 are an example of the electromagnetic wave detection sensor recited in the claims. The electromagnetic wave detection sensor detects visible light. In addition, the electromagnetic wave detection sensor may be a sensor for detecting an electromagnetic wave having a wavelength different from the wavelength of an electromagnetic wave in a visible light range such as infrared light, a submilimeter wave, or a microwave. The plurality of light sensors 252 included in electronic paper 20, to which power is supplied from the power feeder apparatus 40, detects the quantity of irradiated light by using the fed power. Then each of the plurality of pieces of electronic paper 20 transmits information representing the light quantity detected by the light sensors 252, to the information processing apparatus 30.

The information processing apparatus 30 determines a mutual positional relation of the plurality of pieces of electronic paper 20, from the quantity of light received from each of the plurality of pieces of electronic paper 20 via the antenna 322. To be specific, it is determined whether the plurality of pieces of electronic paper 20 are overlapped to each other, or the pieces of electronic paper 20 are in a position visible to the user. For example, when the plurality of pieces of electronic paper 20 are overlapped in a bundle, the uppermost electronic paper 20 of the bundle is in a position visible to the user. In such a case, the information processing apparatus 30 determines that the uppermost electronic paper 20 of the bundle is in a position visible to the user.

To be specific, the information processing apparatus 30 determines that the plurality of pieces of electronic paper 20 are overlapped to each other according to the order of the quantity of light received from each of the plurality of pieces of electronic paper 20. The information processing apparatus 30 determines that the electronic paper 20 whose light sensor 252 has detected the largest quantity of light is in the uppermost position of the bundle, and determines that this electronic paper 20 is in a position visible to the user. Subsequently, the information processing apparatus 30 transmits, to the electronic paper 20 determined to exist in a position visible to the user, data to be displayed by this electronic paper 20. The electronic paper 20, having received the data from the information processing apparatus 30, displays the data.

In addition, each of the plurality of pieces of electronic paper 20 may include a data identifier identifying data to be displayed. The plurality of pieces of electronic paper 20 may transmit the data identifier together with the light quantity to the information processing apparatus 30, in receiving a power supply from the power feeder apparatus 40. Then the information processing apparatus 30 determines a mutual positional relation of the plurality of pieces of electronic paper 20, based on the light quantity received from each of the plurality of pieces of electronic paper 20. Specifically, the information processing apparatus 30 determines the order in which the plurality of pieces of electronic paper 20 are overlapped.

For example, the information processing apparatus 30 determines that the plurality of pieces of electronic paper 20 are overlapped from the uppermost electronic paper 20 of a bundle, in the order from electronic paper 20 having detected the largest quantity of light. Subsequently, the information processing apparatus 30 transmits data identified by each data identifier received from each piece of electronic paper 20, in the order in which the plurality of pieces of electronic paper 20 are overlapped. In other words, the information processing apparatus 30 transmits data to be displayed to the pieces of electronic paper 20, from the electronic paper 20 placed on the uppermost electronic paper 20 of the bundle. Then, electronic paper 20 having received data displays the data.

In addition, the information processing apparatus 30 receives a data identifier from electronic paper 20 having been determined to exist in a position visible to the user. Then the information processing apparatus 30 displays to the monitor 302 data identified by the received data identifier. Subsequently, the information processing apparatus 30 accepts an editing instruction of the user with respect to the data displayed to the monitor 302. For example, the information processing apparatus 30 causes the data to reflect the editing instruction inputted by the user to the information processing apparatus 30 via the keyboard 376 and the mouse 378, and so on. Then the information processing apparatus 30 transmits the edited data to the electronic paper 20 having been determined to exist in a position visible to the user. The electronic paper 20 having received the edited data displays the edited data. When the user has flipped through the plurality of pieces of electronic papers 20, the information processing apparatus 30 is able to determine sequentially different electronic paper 20, as electronic paper 20 existing in a position visible to the user.

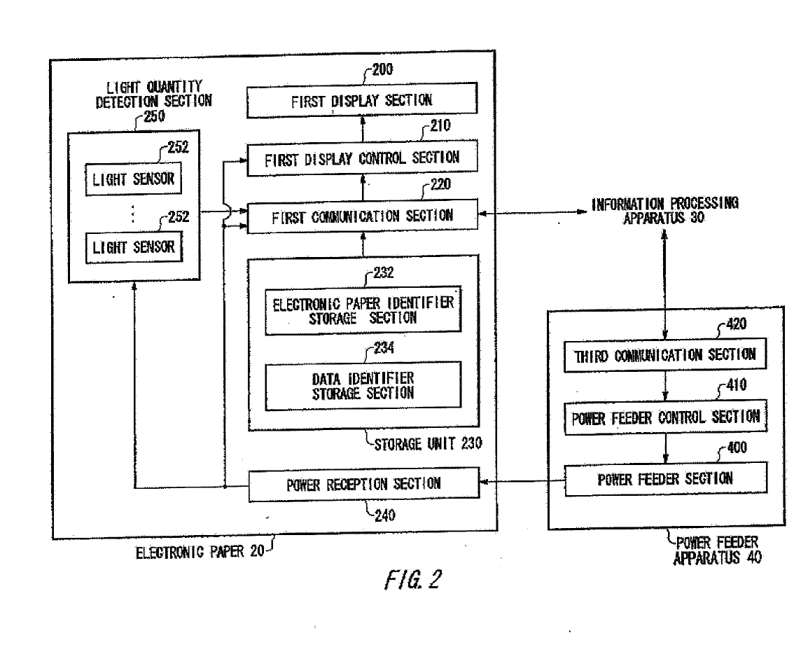

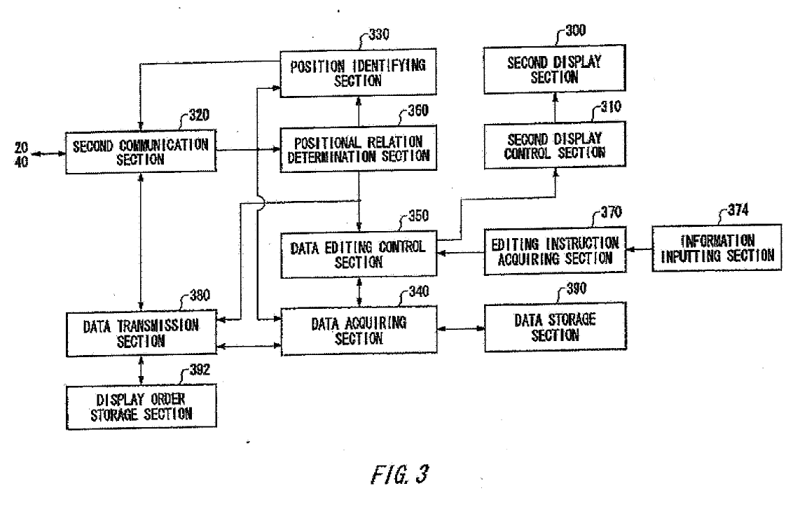

FIG. 2 shows one example of a functional configuration of electronic paper 20 and a power feeder apparatus 40, according to the present embodiment. FIG. 3 shows one example of a functional configuration of an information processing apparatus 30 according to the present embodiment. The electronic paper 20 includes a first display section 200, a first display control section 210, a first communication section 220, a storage unit 230, a power reception section 240, and a light quantity detection section 250. Note that the storage unit 230 includes an electronic paper identifier storage section 232 and a data identifier storage section 234. Further, the light quantity detection section 250 includes a plurality of light sensors 252. Note that the light quantity detection section 250 is one example of the electromagnetic wave strength detection section recited in the claims.

In addition, the power feeder apparatus 40 includes a power feeder section 400, a power feeder control section 410, and a third communication section 420. In addition, the information processing apparats 30 includes a second display section 300, a second display control section 310, a second communication section 320, a position identifying section 330, a data acquiring section 340, a data editing control section 350, a positional relation determination section 360, an editing instruction acquiring section 370, an information inputting section 374, a data transmission section 380, a data storage section 390, and a display order storage section 392.

First, the functional configuration of the power feeder apparatus 40 is explained. The power feeder apparatus 40 generates a magnetic field in a predetermined range, and feeds power to the electronic paper 20. Specifically, the power feeder section 400 included in the power feeder apparatus 40 generates a magnetic field in a predetermined range. For example, the power feeder section 400 feeds power in a condition not directly connected to the power reception section 240 of the electronic paper 20. Note that the power feeder apparatus 40 may include a plurality of power feeder sections 400. In this case, the plurality of power feeder sections 400 may be placed in the range in which the electronic paper 20 is to be placed, in a predetermined interval therebetween. The third communication section 420 receives positional information indicating a position in which the electronic paper 20 resides, from the information processing apparatus 30. The third communication section 420 supplies the received positional information to the power feeder control section 410.

The power feeder control section 410 controls power feeding from the power feeder section 400 to the power reception section 240. The power feeder control section 410 controls the quantity of power fed from the power feeder section 400 to the power reception section 240, by changing the state of magnetic field. In the initial state, the power feeder control section 410 controls the strength of the magnetic field generated by the power feeder section 400, so that power required for operating the first communication section 220 and the light quantity detection section 250 of the electronic paper 20 is supplied from the power feeder section 400 to the power reception section 240. Then the power feeder control section 410 monitors the state of magnetic field generated by the power feeder section 400. When the power reception section 240 exists in the predetermined range from the position of the power feeder section 400, the state of magnetic field generated by the power feeder section 400 changes. Accordingly, when detecting that the state of magnetic field generated by the power feeder section 400 has changed, the power feeder control section 410 may determine that the power reception section 240 exists in a predetermined range from the position of the power feeder section 400, and control so that power is fed from the power feeder section 400 to the electronic paper 20.

In addition, the power feeder control section 410 may supply power required for operating the first display control section 210 of the electronic paper 20, by operating only power feeder sections 400 in the position in which the electronic paper 20 exists, based on the positional relation received from the third communication section 420. For example, the power feeder control section 410 causes, to generate a magnetic field, the power feeder sections 400 positioned in a position identified by the positional information. That is, the power feeder control section 410 causes, to generate a magnetic field, the power feeder sections 400 positioned in a position identified by the positional information, so as to feed power to the electronic paper 20 that the information processing apparats 30 has determined to exist in a position visible to the user. Then the power feeder control section 410 may feed power for operating the first display control section 210, from the power feeder section 400 to the electronic paper 20.

Next, the functional configuration of the electronic paper 20 is explained. The electronic paper 20 displays data such as a document file and an image file. The data displayed by the electronic paper 20 may be data edited by an external information processing apparatus 30. First, the power reception section 240 receives power from the magnetic field generated by the power feeder section 400 included in the power reception apparatus 40. The power reception section 240 supplies the received power to the first display control section 210, the first communication section 220, and the light quantity detection section 250. Note that the power reception section 240 may include an antenna coil. When the power reception section 240 includes an antenna coil, the power reception section 240 is able to receive power in a noncontact manner.

The storage unit 230 stores an electronic paper identifier identifying the electronic paper 20, and a data identifier identifying data displayed by the first display section 200 included in the electronic paper 20. Specifically, the electronic paper identifier storage section 232 stores the electronic paper identifier identifying the electronic paper 20. The data identifier storage section 234 stores the data identifier identifying the data displayed by the first display section 200. A data identifier may be a data name or a name of a file including the data, for example. Furthermore, a data identifier may include information such as URL indicating a location of the data. The storage unit 230 supplies an electronic paper identifier and a data identifier to the first communication section 220, based on the control by the first communication section 220.

The light quantity detection section 250 detects the quantity of light irradiated onto the electronic paper 20, For example, the light quantity detection section 250 detects the quantity of visible light. When the power reception section 240 has received power, the light quantity detection section 250 detects the light quantity using the received power. In addition, the light quantity detection section 250 may include a plurality of light sensors 252 respectively placed in a plurality of predetermined positions of the electronic paper 20. The light quantity detection section 250 supplies the detected light quantity to the first communication section 220.

When the electronic paper 20 has an electromagnetic wave strength detection section detecting the strength of an electromagnetic wave having a wavelength different from the wavelength in a visible light range such as infrared light, a submilimeter wave, or a microwave, the electromagnetic wave strength detection section may detect the strength of an electromagnetic wave irradiated onto the electronic paper 20. The following embodiment deals with a case where the light quantity detection section 250 has detected the light quantity. Information supplied to each constituting element of the present embodiment from the light quantity detection section 250 and the like is information indicating a light quantity. On the other hand, when the light quantity detection section 250 is an electromagnetic wave strength detection section detecting the strength of an electromagnetic wave such as infrared light, a submilimeter wave, or a microwave, information supplied to each constituting element from the electromagnetic wave strength detection section may be information indicating the strength of an electromagnetic wave detected by the electromagnetic wave strength detection section.

The first communication section 220 transmits, to the information processing apparatus 30, an electronic paper identifier stored in the electronic paper identifier storage section 232, a data identifier stored in the data identifier storage section 234, and a light quantity detected by the light quantity detection section 250. In addition, when the electronic paper 20 is placed in a predetermined range to which the power feeder apparatus 40 is generating a magnetic field, and the power reception section 240 has received power, the first communication section 220 may use power received by the power reception section 240 to transmit the electronic paper identifier, the data identifier, and the detected light quantity, to the information processing apparatus 30.

Note that the first communication section 220 may include a plurality of antennas that transmit predetermined information to the information processing apparatus 30. Then the plurality of antennas included in the first communication section 220 may be placed to a plurality of predetermined positions of the electronic paper 20, respectively. For example, the predetermined positions may be four corners of the electronic paper 20. Alternatively, the predetermined positions may be respective vicinities of a plurality of sides of the electronic paper 20 or of a plurality of corners of the electronic paper 20. Furthermore, the plurality of antennas included in the first communication section 220 may be associated with antenna identifiers respectively identifying the plurality of antennas.

In this case, the storage unit 230 included in the electronic paper 20 may further include an antenna identifier storage section storing the antenna identifiers respectively identifying the plurality of antennas. When transmitting an electronic paper identifier to the information processing apparatus 30, the first communication section 220 transmits the electronic paper identifier simultaneously from the plurality of antennas. In this case, the first communication section 220 transmits the electronic paper identifier in association with the antenna identifiers respectively of the plurality of antennas, from the plurality of antennas to the information processing apparatus 30.

The first display control section 210 displays data received from the first communication section 220, to the first display section 200. When predetermined data is already displayed to the first display section 200, the first display control section 210 may update the predetermined data currently on display by the first display section 200, to the contents of the data received from the first communication section 220. Note that the first display control section 210 uses power received by the power reception section 240 to display data to the first display section 200. The first display section 200 displays data identified by a data identifier stored in the data identifier storage section 234. Specifically, the first display section 200, by being controlled by the first display control section 210, displays the data that the first communication section 220 has received from the information processing apparatus 30. Note that the first display section 200 is one example of the display section included in the electronic paper recited in the claims.

Next, the functional configuration of the information processing apparatus 30 shown in FIG. 3 is explained. The information processing apparatus 30 transmits predetermined data to the electronic paper 20 and displays the data to the electronic paper 20. The second communication section 320 receives, from the first communication section 220 of the electronic paper 20, an electronic paper identifier stored in the electronic paper identifier storage section 232, a data identifier stored in the data identifier storage section 234, and a light quantity detected by the light quantity detection section 250. Note that the second communication section 320 may include an antenna 322. Specifically, the second communication section 320 may include at least three antennas 322. Then the second communication section 320 may receive predetermined information transmitted from the electronic paper 20, at each of the at least three antennas 322.

The second communication section 320 supplies the electronic paper identifier and the light quantity to the positional relation determination section 360. In addition, the second communication section 320 supplies the electronic paper identifier to the position identifying section 330 and the data transmission section 380. Note that when the electronic paper 20 has transmitted an electronic paper identifier in association with an antenna identifier, the second communication section 320 supplies the electronic paper identifier associated with the antenna identifier, to the position identifying section 330. In this case, the second communication section 320 further supplies, to the position identifying section 330, the electric field strength caused when the antenna 322 receives the electronic paper identifier associated with the antenna identifier. Furthermore, the second communication section 320 supplies a data identifier to the data acquiring section 340 and the data transmission section 380. In addition, the second communication section 320 transmits predetermined data to the first communication section 220 in predetermined electronic paper 20, based on the control by the data transmission section 380. Furthermore, the second communication section 320 transmits positional information indicating the position of the electronic paper 20, to the third communication section 420 of the power feeder apparatus 40, based on the control by the position identifying section 330.

The data storage section 390 stores data in association with a data identifier. The data storage section 390 supplies data to the data acquiring section 340, by being controlled by the data acquiring section 340. The data acquiring section 340 acquires, from the data storage section 390, data identified by the data identifier received from the second communication section 320. The data acquiring section 340 supplies the acquired data to the data editing control section 350. Furthermore, the data acquiring section 340 supplies the acquired data to the data transmission section 380, based on a request of the data transmission section 380. In addition, the data acquiring section 340 may receive data to which editing has been performed in the data editing control section 350, from the data editing control section 350. In such a case, the data acquiring section 340 may store the data to which editing has been performed in the data editing control section 350, in the data storage section 390.

The information inputting section 374 receives input of information from a user (e.g. an editing instruction by a user directed to the contents of data). A keyboard 376 and a mouse 378 are an example of the information inputting section 374. The information inputting section 374 supplies an editing instruction by a user directed to the contents of data, to the editing instruction acquiring section 370. The editing instruction acquiring section 370 acquires an editing instruction for data from a user, via the information inputting section 374. The editing instruction acquiring section 370 supplies the editing instruction to the data editing control section 350.

The positional relation determination section 360 determines the mutual positional relation of a plurality of pieces of electronic paper 20, from the light quantity detected by light quantity detection sections 250 respectively included in the plurality of pieces of electronic paper 20. To be more specific, the positional relation determination section 360 compares, for each piece of electronic paper 20 identified by an electronic paper identifier received from the second communication section 320, the light quantity detected by the light quantity detection sections 250 respectively included in the pieces of electronic paper 20. Then the positional relation determination section 360 determines the mutual positional relation of the plurality of pieces of electronic paper 20. To be specific, the positional relation determination section 360 determines that the plurality of pieces of electronic paper 20 are overlapped in the order of the light quantity detected by the light quantity detection sections 250 respectively included in the plurality of the pieces of electronic paper 20. Note that the positional relation determination section 360 may determine that the plurality of pieces of electronic paper 20 are overlapped in the order of the strength of the electromagnetic waves detected by electromagnetic wave strength detection sections.

For example, the positional relation determination section 360 determines that electronic paper 20 is positioned further above (i.e. positioned at a position nearer to the light source), as larger light quantity is detected by the light quantity detection section 250 in the electronic paper 20. When the plurality of pieces of electronic paper 20 are overlapped in a bundle, the light quantity detection section 250 of the electronic paper 20 being positioned on the uppermost position detects the largest light quantity. Then from the uppermost electronic paper 20 towards the lower side of the bundle, the light quantity detected by light quantity detection sections 250 gradually decreases. Accordingly, the positional relation determination section 360 is able to determine that the pieces of electronic paper 20 are overlapped in the order starting from the electronic paper, from among the pieces of electronic paper 20, whose light quantity detection section 250 has detected the largest light quantity.

In addition, for example, the positional relation determination section 360 may determine that electronic paper 20 whose electromagnetic wave strength detection section has detected larger electronic wave strength is positioned above the other pieces of electronic paper 20 In other words, when the plurality of pieces of electronic paper 20 are overlapped in a bundle, the electromagnetic wave strength detected by the electromagnetic wave strength detection section becomes gradually smaller towards the lower pieces of electronic paper 20 of the bundle from the uppermost electronic paper 20. Accordingly, the positional relation determination section 360 may determine that the pieces of electronic paper 20 are overlapped in the order starting from the electronic paper 20 whose electromagnetic wave strength detection section has detected larger electromagnetic wave strength.

Furthermore, the positional relation determination section 360 may determine that the electronic paper 20 whose light quantity detection section 250 has detected a predetermined light or more is in a position visible to the user. In addition, the positional relation determination section 360 may determine that the electronic paper 20 whose light quantity detection section 250 has detected the largest light quantity is in a position visible to the user. The positional relation determination section 360 supplies the determination result to the position identifying section 330, the data editing control section 350, and the data transmission section 380. To be specific, the positional relation determination section 360 supplies the order in which the pieces of electronic paper are overlapped, in association with the electronic paper identifiers, to the position identify section 330, the data editing control section 350, and the data transmission section 380.

The display order storage section 392 stores, in association with each of a plurality of data identifiers, the display order of data identified by the data identifiers. To be specific, the display order storage section 392 stores the display order of data stored by the data storage section 390 in association with the data identifiers. For example when the data identified by the data identifiers is document data, the display order of the data identified by the data identifiers stored by the display order storage section 392 in association with the data identifiers may be the order of pages of the document data included in the document data. Moreover, for example when the data is image data, the display order of data stored by the display order storage section 392 may be the display order of the image data. Furthermore, the display order of data stored by the display order storage section 392 may be the order of predetermined file data (e.g. document file, image file, etc.). The display order storage section 392 supplies the display order of data to the data transmission section 380, based on the control by the data transmission section 380.

The data transmission section 380 transmits data to be displayed to the first display sections 200 included in each of the plurality of pieces of electronic paper 20, to each of the plurality of pieces of electronic paper 20, in accordance with the mutual positional relation of the plurality of pieces of electronic paper indicated by the determination result received from the positional relation determination section 360. The data transmission section 380 selects electronic paper 20 to which data is to be transmitted, from the determination result of the mutual positional relation of the plurality of pieces of electronic paper 20 received from the positional relation determination section 360. For example, the data transmission section 380 selects electronic paper 20 determined by the positional relation determination section 360 to be positioned in a position visible to a user, as the electronic paper 20 to which data is to be transmitted. Then the data transmission section 380 acts onto the data acquiring section 340 to acquire the data to be displayed to the selected electronic paper 20. The data transmission section 380 acts onto the second communication section 320 to transmit the data acquired from the data acquiring section 340, to the first communication section 220 included in the selected electronic paper 20.

To be concrete, the data transmission section 380 transmits the data to be displayed to the first display sections 200 respectively included in the plurality of pieces of electronic paper, respectively to the plurality of pieces of electronic paper 20, in the order in which the plurality of pieces of electronic paper 20 are overlapped to each other, which has been determined by the positional relation determination section 360. For example, when a plurality of pieces of electronic paper 20 are overlapped in a bundle, the data transmission section 380 receives, from the positional relation determination section 360, electronic paper identifiers of the plurality of pieces of electronic paper 20, from the electronic paper identifier of the electronic paper 20 positioned on tie uppermost position of the bundle to the lower side sequentially. Then the data transmission section 380 acquires data identified by the data identifier received from the second communication section 320, as data to be displayed to the electronic paper 20 identified by the electronic paper identifier received from the second communication section 320. The data transmission section 380 may act onto the data acquiring section 340, to receive the data that the data acquiring section 340 has acquired from the data storage section 390.

In addition, as for the electronic paper 20 having been determined by the positional relation determination section 360 to exist in a position visible t the user, the data transmission section 380 may transmit the data to be displayed to the first display section 200 included in the particular electronic paper 20 from the second communication section 320 to the first communication section 220. Moreover, as for the plurality of pieces of electronic paper respectively, the data transmission section 380 may transmit respective data identified by the data identifiers stored by either of the plurality of data identifier storage section 234, from the second communication section 320 to the first communication section 220, so as to match the display order of the data stored in the display order storage section 392 to the order in which the plurality of pieces of electronic paper are overlapped which has been determined by the positional relation determination section 360.

The data editing control section 350 permits editing of the contents of data displayed to the first display section 200 included in the electronic paper 20 which the positional relation determination section 360 has determined to exist in a position visible to a user. In other words, when the plurality of pieces of electronic paper 20 are overlapped to each other in a bundle, and when the plurality of pieces of electronic paper 20 are overlapped to each other the data editing control section 350 permits editing of the contents of the data displayed to the electronic paper 20 existing on the uppermost position of the plurality of pieces of electronic paper 20. To be specific, the data editing control section 350 causes the contents of the data received from the data acquiring section 340 to reflect the editing instruction of the user received from the editing instruction acquiring section 370. The data editing control section 350 supplies the data whose contents has been edited, to the data acquiring section 340. The data editing control section 350 supplies the data or the edited data, to the second display control section 310. The second display control section 310 displays the data received from the data editing control section 350, to the second display section 300. The second display section 300 displays the data, based on the control by the second display control section 310.

The position identifying section 330 identifies the position of the electronic paper 20 which the positional relation determination section 360 has determined to exist in a position visible to a user. To be specific, the position identifying section 330 acquires the electronic paper identifier of the electronic paper 20 determined to exist in a position visible to a user. Then the position identifying section 330 extracts an electronic paper identifier that matches the electronic paper identifier of the electronic paper 20 existing in a position visible to the user, from among a plurality of electronic paper identifiers associated with the antenna identifiers received from the second communication section 320. In other words, the position identifying section 330 extracts at least three electronic paper identifiers associated with the antenna identifiers, for the electronic paper 20 determined by the positional relation determination section 360 to exist in a position visible to a user.

The position identifying section 330 performs three-point measurement operation using the electric field strengths respectively occurred when the extracted at least hree pieces of electronic paper are received by the second communication section 320 and the positions of at least three antennas 322 included in the second communication section 320. Then the position identifying section 330 identifies the positions of the at least three antennas included in the electronic paper 20. Following this, the position identifying section 330 identifies the position of the electronic paper 20 and the orientation thereof with respect to the information processing apparatus 30, from the identified positions of the antennas of the electronic paper 20.

It should be noted here that the plurality of pieces of electronic paper 20 may be manufactured respectively based on the predetermined standard, and have substantially the same size and form. Furthermore, the antennas respectively included in the plurality of pieces of electronic paper 20 may also be provided in positions substantially the same for the plurality of pieces of electronic paper 20. Consequently, by identifying the position of an antenna included in electronic paper 20, it becomes possible to accurately identify the relative positions of the plurality of pieces of electronic paper 20 with respect to the information processing apparatus 30. The position identifying section 330 supplies the positional information indicating the position of the identified electronic paper 20, to the second communication section 320. The second communication section 320 transmits the positional information received from the position identifying section 330 to the third communication section 420.

It should be noted that the display system 10 may further include an electronic paper position specifying apparatus for specifying the position of electronic paper 20. When in contact with electronic paper 20, the electronic paper position specifying apparatus acquires a data identifier stored in the data identifier storage section 234 included in the electronic paper 20. For example, the electronic paper position specifying apparats may include a battery therein. In addition, the electronic paper position specifying apparatus may include an electronic-paper-position-specifying-apparatus-side power feeder section for feeding power to the electronic paper 20 by generating a magnetic field in a predetermined range The electronic-paper-position-specifying-apparats-side power feeder section uses power of the battery included in the electronic paper position specifying apparatus, to feed power to the electronic paper 20.

Electronic paper 20 transmits an electronic paper identifier and a data identifier to the electronic paper position specifying apparatus, by using the power fed from the electronic-paper-position-specifying-apparatus-side power feeder section. The electronic paper position specifying apparatus transmits the electronic paper identifier and the data identifier which are received from the electronic paper 200 to the information processing apparatus 30. When the display system 10 includes au electronic paper position specifying apparatus, the positional relation determination section 360 may determine, to be the electronic paper 20 existing on the uppermost position of the plurality of pieces of electronic paper 20, the electronic paper 20 with which the electronic paper position specifying apparatus is caused to be in contact by a user. In such a case, the electronic paper 20 may not include the light quantity detection section 250.

According to the display system 10 according to the present embodiment, it is possible to identify the electronic paper 20 existing in a position visible to the user, by determining the overlapping state of the plurality of pieces of electronic paper 20. Consequently, it is possible to display predetermined data only to the electronic paper 20 existing in a position visible to the user. Accordingly, even when the user has placed a plurality of pieces of electronic paper 20 in a random formation, it is possible to display data desired by a user, only to the electronic paper 20 visible to the user.

In addition, according to the display system 10 according to the present embodiment, only the data displayed to the electronic paper 20 existing in a position visible to the user is made editable in the information processing apparatus 30. Accordingly, a user is able to edit the data displayed to the electronic paper 20 that the user is actually watching.

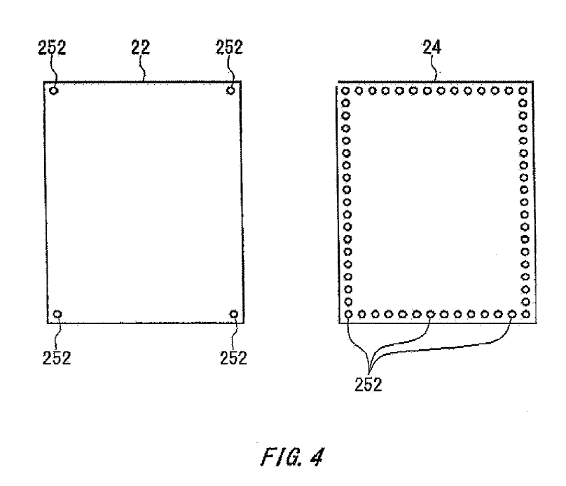

FIG. 4 shows one example of the placement of light sensors 252 included in the light quantity detection section 250 according to the present embodiment. The electronic paper 22 includes a plurality of light sensors 252 placed in the vicinities of a plurality of corners respectively. To be specific, the electronic paper 22 may include light sensors 252 in vicinities of the four corners respectively. For example, in the light quantity detection section 250 included in the plurality of pieces of electronic paper 22, when all of the light sensors 252 at the four corners have detected a predetermined light quantity or more, the positional relation determination section 360 can determine that the electronic paper 22 is in the uppermost position of all the plurality of pieces of electronic paper 22.

In addition, suppose a case where there is electronic paper 22 in which there are four light sensors 252 having detected a predetermined light quantity or more while there is electronic paper 22 in which there is no light sensor 252 having detected a predetermined light quantity or more, out of light sensors 252 at the four corners of electronic paper 22. In this case, the positional relation determination section 360 can determine that the electronic paper 22 in which there is no light sensor 252 having detected a predetermined light quantity or more is positioned at a lower side of the electronic paper 22 in which there are four light sensors 252 having detected a predetermined light quantity or more.

In addition, in electronic paper 24, light sensors 252 are positioned in respective vicinities of a plurality of sides and a plurality of corners of the electronic paper 24. Note that light sensors 252 may be alternatively placed in respective vicinities of a plurality of sides or a plurality of corners of electronic paper 20. For example, when a plurality of pieces of electronic paper 24 are overlapped to each other, the positional relation determination section 360 may determine that a plurality of pieces of electronic paper 24 are overlapped with each other, in the order from electronic paper 24 having more light sensors 252 in number having detected a predetermined light quantity or more, from among a plurality of light sensors 252 included in each of the plurality of pieces of electronic paper 24.

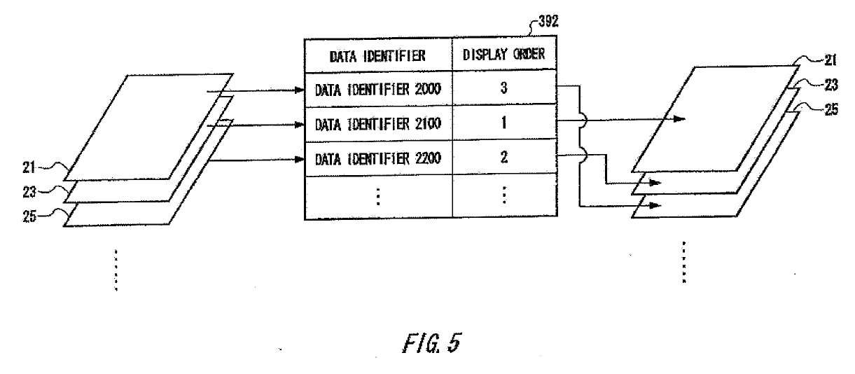

FIG. 5 shows one example of a display system 10 according to the present embodiment. In the display system 10 according to the present embodiment, when a plurality of pieces of electronic paper 20 are overlapped to each other, respective pieces of data identified by data identifiers respectively stored in data identifier storage sections 234 included in the plurality of pieces of electronic paper 20 are sorted in a data display order predetermined in the information processing apparatus 30. Then based on the control by the information processing apparatus 30, the sorted pieces of data are sequentially displayed from the uppermost electronic paper 20 of the plurality of pieces of electronic paper 20 respectively. Note that electronic paper 21, electronic paper 23, electronic paper 25, etc. are one example of the electronic paper 20.

For example, suppose a case where the electronic paper 21, the electronic paper 23, the electronic paper 25, etc., which are described below, are placed to overlap to each other. The data identifier storage sections 234 respectively included in the electronic paper 21, the electronic paper 23, the electronic paper 25, etc. respectively store data identifiers for identifying the data displayed to the electronic paper 21, the electronic paper 23, the electronic paper 25, etc. To be specific, the data identifier storage section 234 included in the electronic paper 21 stores a data identifier 2000. The data identifier storage section 234 included in the electronic paper 23 stores a data identifier 2100. Further, the data identifier storage section 234 included in the electronic paper 25 stores a data identifier 2200.

Here, if the electronic paper 21, the electronic paper 23, the electronic paper 25, etc., which are overlapped in a bundle, are placed on the power feeder apparatus 40, the power feeder apparatus 40 feeds power to the electronic paper 21, the electronic paper 23, the electronic paper 25, etc. respectively. With use of the power fed from the power feeder apparatus 40, the electronic paper 21, the electronic paper 23, the electronic paper 25, etc. transmit, to the information processing apparatus 30, data identifiers respectively stored in the data identifier storage sections 234 included in the electronic paper 21, the electronic paper 23, the electronic paper 25, etc., together with the quantity of light detected by the light quantity detection sections 250 respectively included in the electronic paper 21, the electronic paper 23, the electronic paper 25, etc.

Then the information processing apparatus 30 determines the order in which the electronic paper 21, the electronic paper 23, the electronic paper 25, etc. are overlapped to each other, based on the light quantity received respectively from the electronic paper 21, the electronic paper 23, the electronic paper 25, etc. For example in the example of FIG. 5, the positional relation determination section 360 determines that the electronic paper 21, the electronic paper 23, and the electronic paper 25 are overlapped in the stated order. In addition, the data transmission section 380 acquires data identifiers respectively transmitted from the electronic paper 21, the electronic paper 23, the electronic paper 25, etc. respectively, and determines the data display order identified by the acquired data identifiers, from the display order stored in the display order storage section 392.

To be specific, the data transmission section 380 acquires the display order stored in the display order storage section 392 in association with the data identifier received by the second communication section 320 from the electronic paper 21, the electronic paper 23, the electronic paper 25, etc. Then the data transmission section 380 sorts the data display order identified by data identifiers, so that it equals to the display order acquired from the display order storage section 392.

For example, from the display order stored by the display order storage section 392 in association with the data identifier 2000, the data transmission section 380 determines that the display order of the data identified by the data identifier 2000 received by the second communication section 320 from the electronic paper 21 is the third. Likewise, the data transmission section 380 determines that the display order of the data identified by the data identifier 2100 received by the second communication section 320 from the electronic paper 23 is the first, and that the display order of the data identified by the data identifier 2200 received by the second communication section 320 from the electronic paper 25 is the second.

Subsequently, the data transmission section 380 receives, from the data acquiring section 340, the data to be displayed to the electronic paper 21, the electronic paper 23, the electronic paper 25, etc. Then the data transmission section 380 transmits respective pieces of data received from the data acquiring section 340, to the electronic paper 21, the electronic paper 23, the electronic paper 25, etc, from the second communication section 320, according to the display order. Note that the data transmission section 380 may add page numbers to the data to be transmitted to the electronic paper 21, the electronic paper 23, the electronic paper 25, etc, according to the display order.

For example, the data transmission section 380 transmits the data whose display order is the first, from the second communication section 320 to the first communication section 220 included in the electronic paper 21, so as to display the data identified by the data identifier 2100 to the electronic paper 21 positioned on the uppermost position of an overlap of a plurality of pieces of electronic paper such as the electronic paper 21, the electronic paper 23, the electronic paper 25. Likewise, the data transmission section 380 transmits respective predetermined data to the first communication sections 220 respectively included in the electronic paper 23 and the electronic paper 25, from the second communication section 320, so as to display tire data whose display order is the second to the electronic paper 23 and the data whose display order is the third to the electronic paper 25.

According to the display system 10 according to the present embodiment, even when a user has overlapped a plurality of pieces of electronic paper arbitrarily, the data is displayed from the uppermost electronic paper according to the predetermined data display order. Accordingly, the user does not have to re-arrange the pieces of electronic paper for arranging the data order.

It should be noted hat the present display system 10 is able to display data from the uppermost electronic paper in a predetermined data display order, even when a user has arbitrarily overlapped a plurality of pieces of electronic paper 21, 23, and 25 as explained above. However, when electronic paper once caused to display data is distanced from a former position, the present display system 10 is able to retain the data on display by the electronic paper. In other words, when a plurality of pieces of electronic paper 21, 23, and 25 are distanced from each other after the data transmission section 380 has transmitted the data to be displayed to the respective first display sections 200 of the plurality of pieces of electronic paper 21, 23, and 25, the display system 10 is able to retain the display in the respective first display sections 200 of the plurality of pieces of electronic paper 21, 23, and 25.

The display in the first display sections 200 respectively in the electronic paper 21, 23, and 25 will be retained if there is no power fed from the power feeder apparatus 40. Therefore, when power is fed from the power feeder apparatus 40, data is retained by not performing data transmission from the data transmission section 380. For example, it is possible not to perform data transmission from the data transmission section 380, by inputting a selection such that display of the electronic paper 21, 23, and 25 is not updated, from the information inputting section 374 of the information processing apparatus 30.

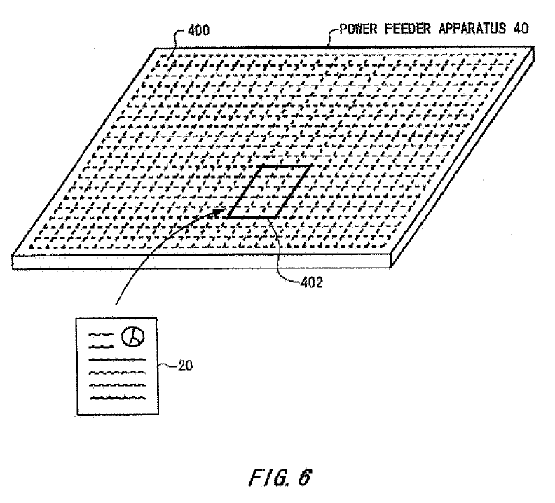

FIG. 6 shows one example of the power feeder apparatus 40 according to the present embodiment. The power feeder apparatus 40 includes a plurality of power feeder sections 400 placed at a predetermined interval therebetween in the range in which the electronic paper 20 is to be placed. The plurality of power feeder sections 400 included in the power feeder apparatus 40 supply power to the power reception section 240 included in the electronic paper 20 in a noncontact manner and electromagnetically. Note that each power feeder section 400 may include a coil for power feeding purpose. That is, the power feeder section 400 generates an electromagnetic wave from the power feeder coil. Then the power reception section 240 may receive power from the power feeder section 400, by generating an induction power in response to reception of the electromagnetic wave generated by the power feeder coil of the power feeder section 400.

To be specific, when electronic paper 20 is placed in the area 402, the power feeder apparatus 40 generates a magnetic field only from the plurality of power feeder sections 400 existing in the area 402, to feed power to the electronic paper 20. For example, the power feeder control section 410 included in the power feeder apparatus 40 monitors the state of the magnetic field generated by the power feeder section 400. When a power reception section 240 included in the electronic paper 20 exists within a predetermined range from the position of the power feeder section 400, the state of the magnetic field generated by the power feeder section 400 changes. The power feeder control section 410 operates a power feeder section 400 upon detection of the change in the state of the magnetic field generated by the power feeder section 400.

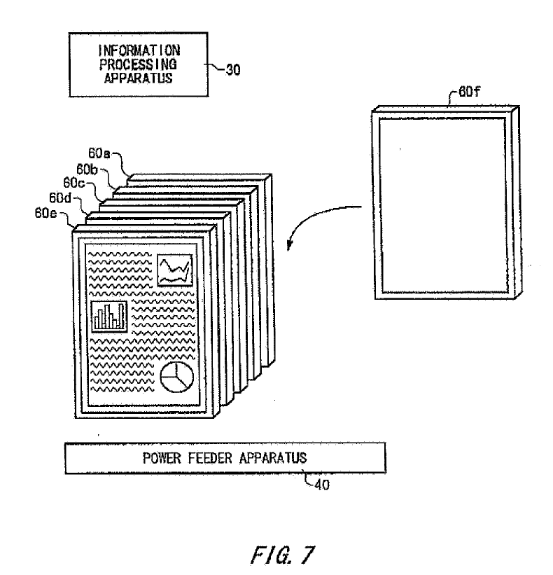

FIG. 7 shows another example of the display system. The present display system includes electronic paper 60a, 60b, 60c, 60d, 60e, 60f, an information processing apparats 30, and a power feeder apparatus 40. Since the information processing apparatus 30 and the power feeder apparatus 40 are the same as those described above, and so the explanation thereof is omitted in the following. The electronic paper 60a—the electronic paper 60e are placed to overlap to each other, and data to be displayed is transmitted from the information processing apparatus 30 and is on display, just as in the case of the electronic paper 21, 23, 25, described above.

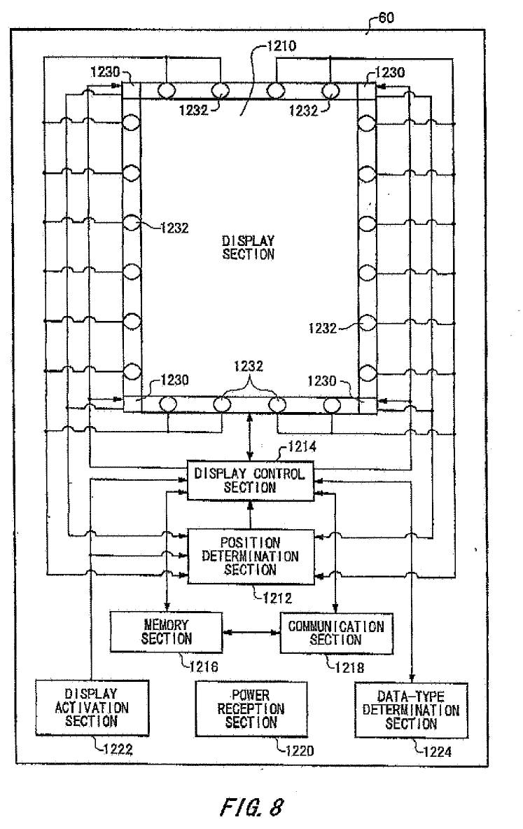

FIG. 8 shows one example of the electronic paper 60a—the electronic paper 60f. The electronic paper 60 (Since the electronic paper 60a—the electronic paper 60f have the same structure and function, which does not require distinction from each other, and so are collectively referred to as “electronic paper 60 ” in the following) includes a display section 1210, a position determination section 1212, a display control section 1214, a memory section 1216, a communication section 1218, a power reception section 1220, a display activation section 1222, and a data-type determination section 1224. The display section 1210 includes a plurality of signal transmission/reception sections 1230 and a plurality of light sensors 1232. Note that in case of expressing each member of the electronic paper 60a—the electronic paper 60f, alphabet such as a-f is added to the name of the member (e.g. display section 1210a).

The display section 210, by being controlled by the display control section 1214, displays data such as characters (text), diagrams, and images. The display section 1210 retains display even when the power supply feeding to the electronic paper 60 is cut off. Display/non-display of the display section 1210 for each pixel is controlled by either a passive matrix or an active matrix. Use of a color filter, or a coloring material as a pixel material realizes color display.

The display section 1210 includes a plurality of signal transmission/reception sections 1230. For example, the signal transmission/reception sections 1230 may be provided at the four corners of the display section 1210. A signal transmission/reception section 1230 is one example of a signal transmission section and a signal reception section. In the present embodiment, a signal transmission/reception section 1230 has both of a signal reception function and a signal transmission function. However, a signal transmission/reception section 1230 may be divided into a signal reception section and a signal transmission section.

The signal transmission/reception section 1230 transmits an identification signal for identifying from which placement position of each display section the particular sign is transmitted. In other words, the signal transmission/reception section 1230 transmits an identification signal unique to the signal transmission/reception section 1230. One exemplary identification method is a method of assign a transmission frequency for each identification signal. Another exemplary identification method is a method of assigning an identification code for an identification signal. It the case where an identification code is assigned and an identification signal is transmitted with use of the same frequency, it is possible to introduce a negotiation process of controlling a transmission timing for each signal transmission/reception section 1230 in view of preventing cross talk.

In addition, the signal transmission/reception section 1230 receives each identification signal transmitted by the plurality of signal transmission/reception sections 1230. Note that since each display section 1210 includes a signal transmission/reception section 1230, the display section 1210 in each piece of electronic paper in the present embodiment is to include a signal transmission section and a signal reception section, as the signal transmission/reception section 1230. However, in the case of dividing signal transmission/reception sections 1230 into signal transmission sections and signal reception sections, any one of the display sections may include a signal reception section, and the other display sections may include a signal transmission section. When the positional relation determination section 360 in the information processing apparatus 30 determines the positional relation between each display section, each display section may include a signal transmission section.

A plurality of light sensors 1232 are disposed in the peripheral area of the display section 1210. A light sensor 1232 detects light in the peripheral area of the display section 1210. A photosensor having sensitivity in the visible light region is an example of the light sensor 1232.

The position determination section 1212 determines a positional relation of the display section 1210 in each piece of electronic paper 60. For example, by receiving an identification signal from a signal transmission/reception section 1230 or a light strength signal from a light sensor 1232, the position determination section 1212 determines the positional relation of each display section 1210 using these signals. Note that each piece of electronic paper 60 includes a position determination section 1212. However when the positional relation determined by any of the position determination sections 1212 is able to be transmitted to another piece of electronic paper, they may not operate independently. In addition, when the positional relation determination section 360 of the information processing apparatus 30 determines the positional relation between each display section, the position determination section 1212 in each piece of electronic paper may not operate.

When determining the positional relation in response to reception of an identification signal from the sign transmission/reception section 1230, the position determination section 1212 may operate in the following manner, for example. That is, the position determination section 1212 identifies the position of the signal transmission/reception section 1230 having transmitted the identification signal, from each placement position of the signal transmission/reception section 1230 having received the identification signal in the display section 1210 and from the strength of the identification signal received by the signal transmission/reception section 1230 in each placement position, using the display section 1210 at the reception side as a reference. For example when the display section 1210a is used as a reference, each signal transmission/reception section 1230a placed at four corners of the display section 1210a receives each identification signal from respective signal transmission/reception sections 1230b-1230f placed at four corners of the display sections 1210b-1210f.

By equalizing the transmission strength of an identification signal or performing calibration by measuring the reception strength in a known distance, the reception strength of a signal will be a function of a distance. Accordingly, it becomes possible to obtain a distance up to an arbitrary signal transmission/reception section 1230 at the transmission side, by measuring the strength of an identification signal for an arbitrary signal transmission/reception section 1230 at the reception side. The placement position of a signal transmission/reception section 1230 in a display section 1210 is known. Therefore by measuring the strength of an identification signal in at least three places out of the signal transmission/reception section 1230 (e.g. signal transmission/reception section 1230a) of the display section 1210 at the reception side (e.g. display section 1210a), it becomes possible to identify the position of the signal transmission/reception section 1230 (e.g. signal transmission/reception section 1230b) having transmitted the identification signal, using the display section 1210 at the reception side as a reference.

If such identification of a signal transmission/reception section 1230 is performed in at least three places of the display section 1210 at the transmission side (e.g. display section 1210b), it is possible to identity the position of the display section 1210 at the transmission side using the display section 1210 at the reception side as a reference. That is, from the identified position of the signal transmission/reception section 1230 at the transmission side (one example of signal transmission section) and the placement position of the signal transmission/reception section 1230 at the transmission side in the display section 1210, the positional relation between the display sections 1210 at the transmission side and at the reception side (one example of the first display section and the second display section) is determined.

When determining the positional relation in response to reception of a light strength signal from a light sensor 1232, the position determination section 1212 may determine in the similar manner to the above-described case where the light sensors 252 are used. That is, pieces of electronic papers 60 can be determined to be overlapped to each other, in the order from electronic paper 60 having more light sensors 1232 having detected a predetermined light quantity or more, from among the plurality of pieces of electronic paper 60 respectively having a plurality of light sensors 1232.

Note that the following positional relation is one example of the positional relation able to be determined by the position determination section 1212. That is, an overlapping relation in which display sections 1210 are overlapped to each other, an adjacent relation in which display sections 1210 are adjacent to each other, an identical direction relation in which display sections 1210 are placed in the identical direction, a different direction relation in which display sections 1210 are placed in different directions from each other, or a held-up relation where display sections 1210 are placed off from the display surface.

The display control section 1214 controls data display directed to the display section 1210. When one piece of electronic paper 60 (e.g. electronic paper 60e) and another piece of electronic paper 60 (e.g. electronic paper 60f) cooperate with each other, for example the display control section 1214f displays partial data of the display data on display by the display section (display section 1210e) of the one piece of electronic paper or adjacent document data adjacent to the display data, to the display section (e.g. display section 1210f) of the other piece of electronic paper. Note that for example the display to the display section 1210f is directly controlled by the display control section 1214f. However, it is also possible that the display control section 1214e or the data transmission section 380 of the information processing apparatus 30 generate the partial data or the adjacent document data according to the positional relation, transmit the same to the electronic paper 60f, to be displayed to the display section 1210f for example.

The memory section 1216 records data to be displayed to the display section 1210. In addition, the memory section 1216 provides a work area used when the display control section 1214 controls the display of the display section 1210. The memory section 1216 performs transmission/reception of data with the communication section 1218 either via the display control section 1214 or directly.

The communication section 1218 communicates with other electronic paper 60. In addition, the communication section 1218 interfaces communication with devices controlling the electronic paper 60 such as the information processing apparatus 30.

The power reception section 1220 receives power from the power feeder apparatus 40. When feeding power by means of magnetic induction, a coil is used for example. When feeding power by means of electromagnetic waves, an antenna is used for example. It is preferable that power is fed to the power reception section 1220 wirelessly, but power may be fed wirelessly. In addition, power feeding by means of an electric battery or other types of batteries may be also adopted.

The display activation section 1222 generates a display activation signal indicating activation of display processing of data to be displayed to the display section 1210. That is, the display activation section 1222 generates a display activation signal to activate update of the display data on display by the display section 1210.

When the display activation section 1222 has generated a display activation signal, the display activation signal is inputted to the position determination section 1212 and the display control section 1214, and the position determination section 1212 having received the display activation signal determines the positional relation at the time of display activation, which is a positional relation between the display section 1210 and the display section 1210 of the other piece of electronic paper at the time of reception of the display activation signal. Then the display control section 1214 having received the display activation signal displays either partial data of the display data on display by the display section 1210 of the other piece of electronic paper 60, partial data of the adjacent document data, or the adjacent document data to the display section 1210, depending on the positional relation at the time of display activation.

As a generation trigger of a display activation signal, it is possible to provide a switch for detecting an operation of a user. In this case, the display activation section 1222 generates a display activation signal by detecting an operation to the switch. Or, it is possible to use a light sensor 1232 as a generation trigger of a display activation signal. In this case, the display activation section 1222 may generate a display activation sign by detecting that the strength of light detected at tie light sensor 1232 is lowered to a predetermined value.

It is also possible to use a timer included in a display section 1210, as a generation trigger of a display activation signal. That is, a display section 1210 includes a timer section that is reset when the display section 1210 is placed in a predetermined place. The display activation section 1222 can generate a display activation signal by detecting that the number of count at the timer section in the display section 1210 is lowered compared to the number of counts at the timer section in the display section 1210 of the other piece of electronic paper 60.

Furthermore, it is possible to use a feeding start of power from the power feeder apparatus 40, as a generation trigger of a display activation signal. That is, the display activation section 1222 may generate a display activation signal by detecting a feeding start of power to the display section 1210.

The data-type determination section 1224 determines the type of display data to be displayed to the display section 1210. Accordingly, the display to the display section 1210 is able to be performed according to the type of the display data. That is, the display control section 1214 displays, to the display section 1210, partial data or adjacent document data of the display data on display by the other display section 1210, depending on the type of data determined by the data-type determination section 1224.

For example, when the type of data determined by the data-type determination section 1224 is a document type, the display control section 1214 displays the former page or the next page of the document page on display by tie other display section, to the display section 1210 depending on the positional relation determined by the position determination section 1212. Or, when the type of data determined by tie data-type determination section 1224 is an image type, the display control section 1214 changes the direction of the line of vision or the rotation angle of a stereoscopic image displayed by the other display section, according to the positional relation determined by to position determination section 1212. Then the display control section 1214 displays the stereoscopic image of which the direction of the line of vision or the rotation angle has been changed, to the display section 1210.

According to the display system of the present embodiment, various mutual positional relation of each electronic paper 60a-60f are selected and placed, thereby enabling display of for example partial data or adjacent document data of the display data on display by the display section 1210e of the electronic paper 60e, in various manners in accordance with the positional relation, to the display section 1210f of the electronic paper 60f for example. In addition, by having the data-type determination section 1224, the data is able to be displayed in a manner suitable to the type of the display data, to the display section 1210f for example. Furthermore, by having a display activation section 1222, it is possible to display partial data or adjacent document data of the display data on display by the other display section 1210, by re-activating the electronic paper 60e and the like to the display section 1210e thereof and the like. As follows, different display manners rendered by a positional relation between the display section 1210e and the display section 1210f for example are detailed specifically.

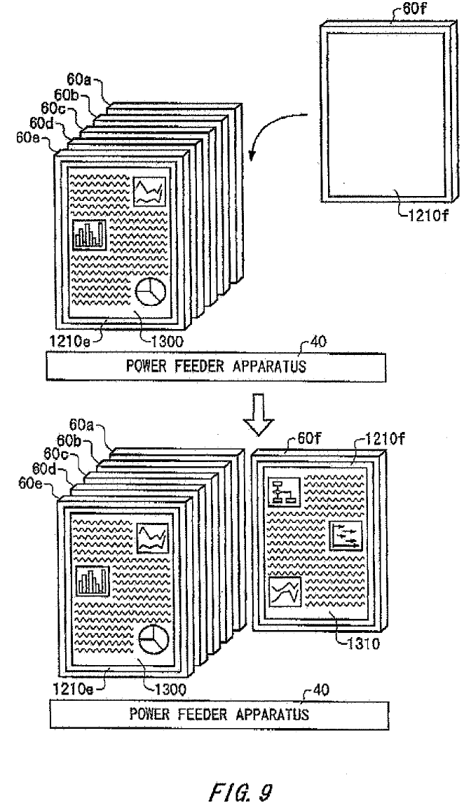

FIG. 9 shows a display example in the present display system. The display example shown here is a display manner in which display is performed to the display section 1210f when the electronic paper 60e and the electronic paper 60f are in the adjacent relation. In tis drawing, the electronic paper 60a—the electronic paper 60e are placed to overlap to each other. In addition, the upper portion in the drawing shows an example before placing the electronic paper 60f adjacent to the electronic paper 60e, and the lower portion shows an example after placing the electronic paper 60f adjacent to the electronic paper 60e.

Prior to placing the electronic paper 60f, the display section 1210e of the electronic paper 60e displays tie display data 1300. In this example the display data 1300 is document data, and one page of document is displayed to the display section 1210e. On the other hand, the display section 1210f of the electronic paper 60f does not display anything here.

Here, the electronic paper 60f is placed to be adjacent to the electronic paper 60e (lower part of the same drawing). Then the power reception section 1220f of the electronic paper 60f receives power from the power feeder apparatus 40, and each section in the electronic paper 60f starts operating. The display activation section 1222 generates a display activation signal by detecting a power feeding start to the power reception section 1220f. A display activation signal is supplied to the position determination section 1212f and the display control section 1214f, and the position determination section 1212f determines the positional relation between the electronic paper 60e and the electronic paper 60f.

Note that it is also possible to transmit a display activation signal to the electronic paper 60e, and to determine the positional relation between the electronic paper 60e and the electronic paper 60f by the position determination section 1212e of the electronic paper 60e. Alternatively, the positional relation determination section 360 of the information processing apparatus 30 may determine the positional relation.

In the present example, since the electronic paper 60f is placed to be adjacent to the electronic paper 60e, the positional relation between tie display section 1210e and the display section 1210f determined by the position determination section 1212f will be an adjacent relation. The positional relation information indicating the adjacent relation is transmitted from the position determination section 1212f to the display control section 1214f as a positional relation code for example. The display control section 1214f having acquired the positional relation displays the next page 1310 being adjacent data of the display data 1300, to the display section 1210f, based on the information indicating the adjacent relation. Note that the data of the next page 1310 may be acquired from either the electronic paper 60e or the information processing apparatus 30 via the communication section 1218f.

According to the display system of the present example, it is possible to display the next page 1310 being adjacent document data of the display data 1300 on display by the display section 1210e to the display section 1210f, based on the determination that the positional relation between the display section 1210e and the display section 1210f is an adjacent relation. As a result, a user becomes able to display the next page by simply placing the electronic paper 60f adjacent to the electronic paper 60e, which enhances usability for a user. Note that the electronic paper 60f is placed on the right side of the electronic paper 60e in the present example, however the electronic paper 60f may be placed on the left side of the electronic paper 60e. Such a case also corresponds to an adjacent relation, however differs in the adjacent position. Therefore, based on this adjacent position difference, it is also possible to display the former page of the display data 1300 to the display section 1210f of the electronic paper 60f placed on the left side, for example.

Moreover, in the present example, an adjacent document page is displayed to the display section 1210f, according to the adjacent relation in which the display section 1210f is adjacent to the display section 1210e. However, the present example also corresponds to a case where the display section 1210f is arranged in the identical direction to the display section 1210e. Therefore, it is also possible to display the adjacent document page to the display section 1210f based on the identical direction relation.

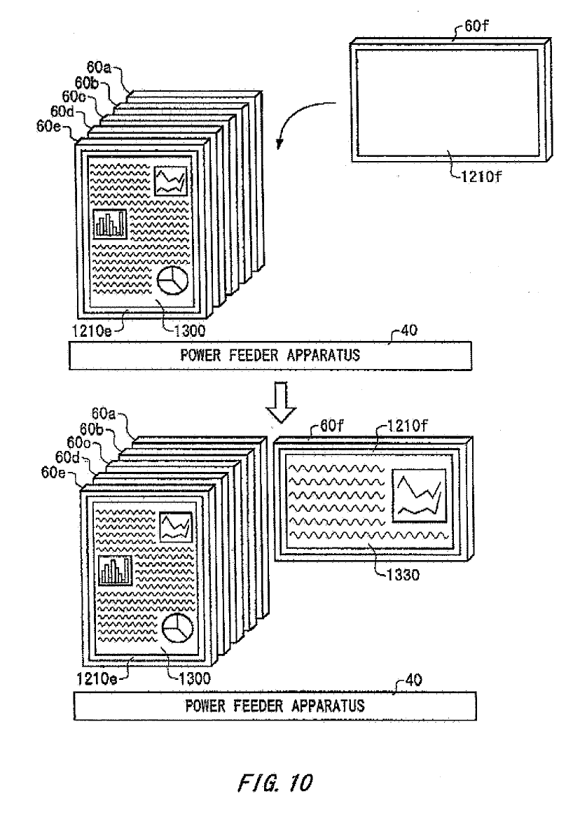

FIG. 10 shows another display example in the present display system. This display example shows a display manner with respect to the display section 1210f when the electronic paper 60e and the electronic paper 60f are in different directions from each other and that in an adjacent relation. In this drawing, the electronic paper 60a—the electronic paper 60e are placed to overlap to each other as in the former example. In addition, in the same drawing, the upper portion shows an example before placing the electronic paper 60f adjacent to the electronic paper 60e and that in a different direction from the direction of the electronic paper 60e and the lower portion shows an example after the electronic paper 60f is placed to be adjacent to the electronic paper 60e and that in a different direction from the direction of the electronic paper 60e.

Prior to placing the electronic paper 60f, the display section 1210e of the electronic paper 60e displays the display data 1300. In this example the display data 1300 is document data, and one page of document is displayed to the display section 1210e. However the display data 1300 may not be document data. For example, the display data 1300 may alternatively be graphic data or three-dimensional graphic data such as a map. On the other hand, the display section 1210f of the electronic paper 60f does not display anything here.

Here, the electronic paper 60f is placed to be adjacent to the electronic paper 60e, and in a different direction from the direction of the electronic paper 60e (lower par of the same drawing). Then the power reception section 1220f of the electronic paper 60f receives power from the power feeder apparatus 40, and each section in the electronic paper 60f starts operating. The display activation section 1222 generates a display activation signal by detecting a power feeding start to the power reception section 1220f. A display activation signal is supplied to the position determination section 1212f and the display control section 1214f, and the position determination section 1212f determines the positional relation between the electronic paper 60e and the electronic paper 60f.

Note that it is also possible to transmit a display activation signal to the electronic paper 60e, and to determine the positional relation between the electronic paper 60e and the electronic paper 60f by the position determination section 1212e of the electronic paper 60e. Alternatively, the positional relation determination section 360 of the information processing apparatus 30 may determine the positional relation.

In the present example, since the electronic paper 60f is placed to be adjacent to the electronic paper 60e and that in a different direction from the direction of the electronic paper 60e, the positional relation between the display section 1210e and the display section 1210f determined by the position determination section 1212f will be an adjacent relation and a different direction relation. The positional relation information indicating the adjacent relation and the different direction relation is transmitted from the position determination section 1212f to the display control section 1214f as a positional relation code for example. The display control section 1214f having acquired the position relation performs enlarged display of partial data 1330 of the display data 1300, to the display section 1210f, based on the information indicating the adjacent relation and the different direction relation. Note that the partial data 1330 may be acquired from either the electronic paper 60e or the information processing apparatus 30 via the communication section 1218f.

According to the display system of the present example, it is possible to perform enlarged display of the partial data 1330 of the display data 1300 on display by the display section 1210e, to the display section 1210f, based on the determination that the positional relation between the display section 1210e and the display section 1210f is an adjacent relation and a different direction relation. As a result, a user becomes able to perform enlarged display of the partial data 1330 of the display data 1300 by simply placing the electronic paper 60f adjacent to the electronic paper 60e and in a different direction from that of the electronic paper 60e, which enhances usability for a user. Note that the electronic paper 60f is placed on the right side of the electronic paper 60e in the present example, however the electronic paper 60f may be placed on the left side of the electronic paper 60e.

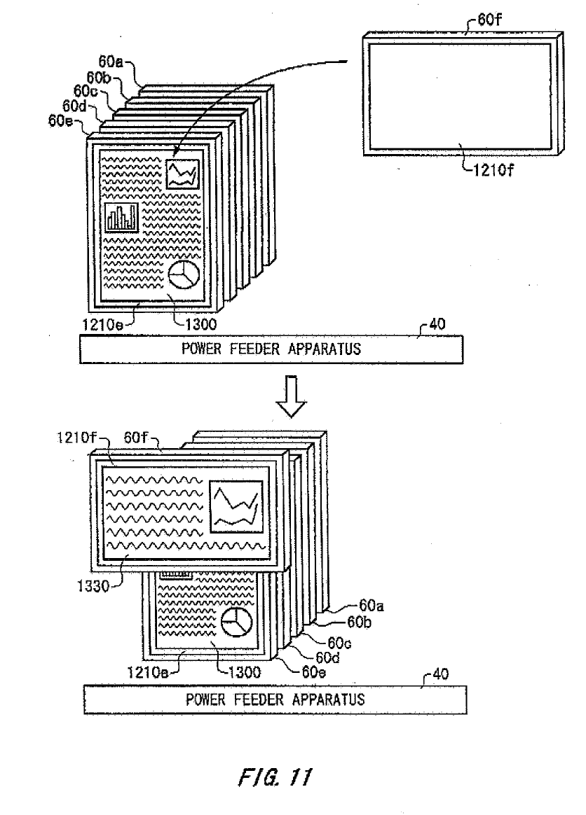

FIG. 11 shows another display example in the present display system. The display example shown here is a display manner in which display is performed to the display section 1210f when the electronic paper 60e and the electronic paper 60f are in the overlapping relation. In this drawing, the electronic paper 60a—the electronic paper 60e are placed to overlap to each other, just as in the former example. In addition, the upper portion in the drawing shows an example before placing the electronic paper 60f to overlap on the electronic paper 60e, and the lower portion shows an example after placing the electronic paper 60f to overlap on the electronic paper 60e.

Prior to placing the electronic paper 60f, the display section 1210e of the electronic paper 60e displays the display data 1300. In this example the display data 1300 is document data, and one page of document is displayed to the display section 1210e. However the display data 1300 may not be document data. For example, the display data 1300 may alternatively be graphic data or three-dimensional graphic data such as a map. On the other hand, the display section 1210f of the electronic paper 60f does not display anything here.

Here, the electronic paper 60f is placed to overlap on the electronic paper 60e (lower part of the same drawing). Then the power reception section 1220f of the electronic paper 60f receives power from the power feeder apparatus 40, and each section in the electronic paper 60f starts operating. The display activation section 1222 generates a display activation signal by detecting a power feeding start to the power reception section 1220f. A display activation signal is supplied to the position determination section 1212f and the display control section 1214f, and the position determination section 1212f determines the positional relation between the electronic paper 60e and the electronic paper 60f.

Note that it is also possible to transmit a display activation signal to the electronic paper 60e, and to determine the positional relation between the electronic paper 60e and the electronic paper 60f by the position determination section 1212e of the electronic paper 60e. Alternatively, the positional relation determination section 360 of the information processing apparatus 30 may determine the positional relation.

In the present example, since the electronic paper 60f is placed to overlap on the electronic paper 60e, the positional relation between the display section 1210e and the display section 1210f determined by the position determination section 1212f will be an overlapping relation. The positional relation information indicating the overlapping relation is transmitted from the position determination section 1212f to the display control section 1214f as a positional relation code for example. The display control section 1214f having acquired the positional relation performs enlarged display of partial data 1330 of the display data 1300, to the display section 1210f, based on the information indicating the overlapping relation. Note that the partial data 1330 may be acquired from either the electronic paper 60e or the information processing apparatus 30 via the communication section 1218f.

According to the display system of the present example, it is possible to perform enlarged display of the partial data 1330 of the display data 1300 on display by the display section 1210e, to the display section 1210f, based on the determination that the positional relation between the display section 1210e and the display section 1210f is an overlapping relation. As a result, a user becomes able to perform enlarged display of the partial data 1330 of the display data 1300 by simply placing the electronic paper 60f to be overlapped on the electronic paper 60e, which enhances usability for a user.

Moreover, in the present example, enlarged display of partial data 1330 of the display data 1300 is performed to the display section 1210f, according to the overlapping relation in which the display section 1210f is placed to overlap on the display section 1210e. However, the present example also corresponds to a case where the display section 1210f is arranged in a different direction from that of the display section 1210e. Therefore, it is also possible to perform enlarged display of the partial data 1330 of the display data 1300 to the display section 1210f based on such a different direction relation.

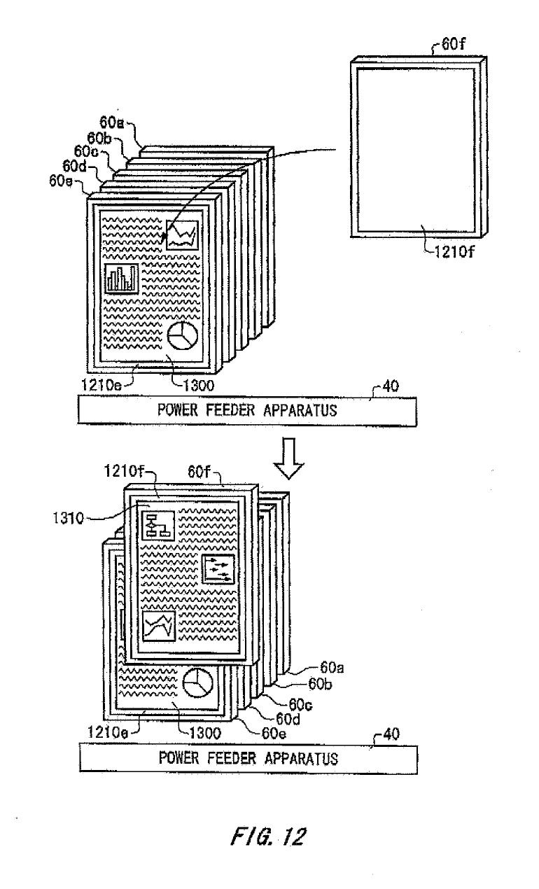

FIG. 12 shows another display example in the present display system. Here, the display example shows a display manner with respect to the display section 1210f when the electronic paper 60e and the electronic paper 60f are in an overlapping relation and in an identical direction. In this drawing, the electronic paper 60a—the electronic paper 60e are placed to overlap to each other as in the former example. In addition, in the same drawing, the upper portion shows an example before placing the electronic paper 60f to overlap on the electronic paper 60e and the lower portion shows an example after the electronic paper 60f is placed to overlap on the electronic paper 60e.

Prior to placing the electronic paper 60f, the display section 1210e of the electronic paper 60e displays the display data 1300. In this example the display data 1300 is document data, and one page of document is displayed to the display section 1210e. On the other hand, the display section 1210f of the electronic paper 60f does not display anything here.

Here, the electronic paper 60f is placed to overlap on the electronic paper 60e and that in the identical direction to that of the electronic paper 60e (lower part of the same drawing). Then the power reception section 1220f of the electronic paper 60f receives power from the power feeder apparatus 40, and each section in the electronic paper 60f starts operating. The display activation section 1222 generates a display activation signal by detecting a power feeding start to the power reception section 1220f. A display activation signal is supplied to the position determination section 1212f and the display control section 1214f, and the position determination section 1212f determines the positional relation between the electronic paper 60e and the electronic paper 60f.

Note that it is also possible to transmit a display activation signal to the electronic paper 60e, and to determine the positional relation between the electronic paper 60e ad the electronic paper 60f by the position determination section 1212e of the electronic paper 60e. Alternatively, the positional relation determination section 360 of the information processing apparatus 30 may determine the positional relation.

In the present example, since the electronic paper 60f is placed to overlap on the electronic paper 60e and that in an identical direction to that of the electronic paper 60e, the positional relation between the display section 1210e and the display section 1210f determined by the position determination section 1212f will be an overlapping relation and an identical direction relation. The positional relation information indicating the overlapping relation and the identical direction relation is transmitted from the position determination section 1212f to the display control section 1214f as a positional relation code for example. The display control section 1214f having acquired the positional relation displays the next page 1310 being adjacent document data of the display data 1300, to the display section 1210f, based on the information indicating the overlapping relation and the identical direction relation. Note that the next page 1310 can be acquired from either the electronic paper 60e or the information processing apparatus 30 via the communication section 1218f.

According to the display system of the present example, it is possible to display the next page 1310 of the display data 1300 on display by the display section 1210e to the display section 1210f, based on the determination that the positional relation between the display section 1210e and the display section 1210f is an overlapping relation and an identical direction relation. As a result, a user becomes able to display the next page 1310 of the display data 1300 by simply placing the electronic paper 60f to overlap on the electronic paper 60e and that in the identical direction to that of the electronic paper 60e, which enhances usability for a user.

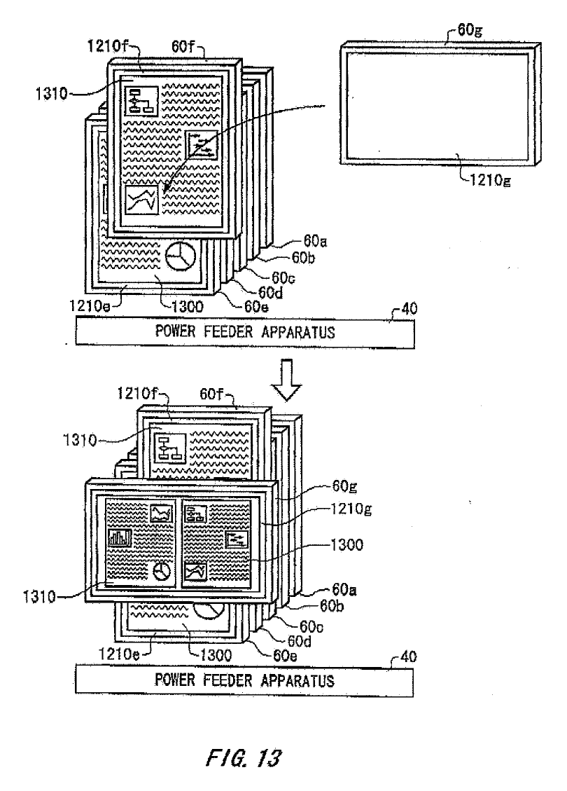

FIG. 13 shows another display example in the present display system. The display example shown here is a display manner in which display is performed to the display section 1210g, in placing the electronic paper 60g in a different direction relation and an overlapping relation as a continuation to the display example of FIG. 12. In this drawing, the electronic paper 60a—the electronic paper 60e are placed to overlap to each other as in the former example, and the electronic paper 60f is placed to overlap on the electronic paper 60e in accordance with the display example of FIG. 12. In addition, the upper portion in the drawing shows an example before placing the electronic paper 60g to overlap on the electronic paper 60f, and the lower portion shows an example after placing the electronic paper 60g to overlap on the electronic paper 60f.

Prior to placing the electronic paper 60g, the display section 1210e of the electronic paper 60e displays the display data 1300, and the display section 1210f of the electronic paper 60f displays the next page 1310 being adjacent document data of the display data 1300. In this example the display data 1300 is document data, and one page of document is displayed to the display section 1210e. In addition, the next page 1310 is document data, and one page of document is displayed to the display section 1210f. On the other hand, the display section 1210g of the electronic paper 60g does not display anything here.

Here, the electronic paper 60g is placed to be in a different direction from that of the electronic paper 60f, and to overlap on the electronic paper 60f (lower part of the same drawing). Then the power reception section 1220g of the electronic paper 60g receives power from the power feeder apparatus 40, and each section in the electronic paper 60g starts operating. The display activation section 1222 generates a display activation signal by detecting a power feeding start to the power reception section 1220g. A display activation signal is supplied to the position determination section 1212g and the display control section 1214g, and the position determination section 1212g determines the positional relation between the electronic paper 60f and the electronic paper 60g.

Note that it is also possible to transmit a display activation signal to the electronic paper 60f, to determine the positional relation between the electronic paper 60f and the electronic paper 60g by the position determination section 1212f of the electronic paper 60f. Alternatively, the positional relation determination section 360 of the information processing apparatus 30 may determine the positional relation.

In the present example, since the electronic paper 60g is placed to be in a different direction from that of the electronic paper 60f, and to overlap on the electronic paper 60f, the positional relation between the display section 1210f and the display section 1210g determined by the position determination section 1212g will be an overlapping relation and a different direction relation. The positional relation information indicating the overlapping relation and the different direction relation is transmitted from the position determination section 1212g to the display control section 1214g as a positional relation code for example. The display control section 1214g having acquired the positional relation performs reduced display of the display data 1300 and the next page 1310 being adjacent document data of the display data 1300, to the display section 1210g, based on the information indicating the overlapping relation and the different direction relation. Note that the display data 1300 and the next page 1310 may be acquired from either the electronic paper 60e, 60f, or the information processing apparatus 30 via the communication section 1218g.

According to the display system of the present example, it is possible to display the display data 1300 on display by the display section 1210e and the next page 1310 on display by the display section 1210f to the display section 1210g, based on the determination that the positional relation among the display section 1210e, the display section 1210f, and the display section 1210g is an overlapping relation and a different direction relation. As a result, a user becomes able to perform reduced display of the display data 1300 and the next page 1310 by simply placing the electronic paper 60g to be in a different direction from that of the electronic paper 60e and the electronic paper 60f and to overlap on the electronic paper 60e and the electronic paper 60f, which enhances usability for a user. Note that in the present example, the display data 1300 and the next page 1310, which correspond to two pages, are subjected to reduced display. However, it is also possible to perform reduced display of tree or more pages.

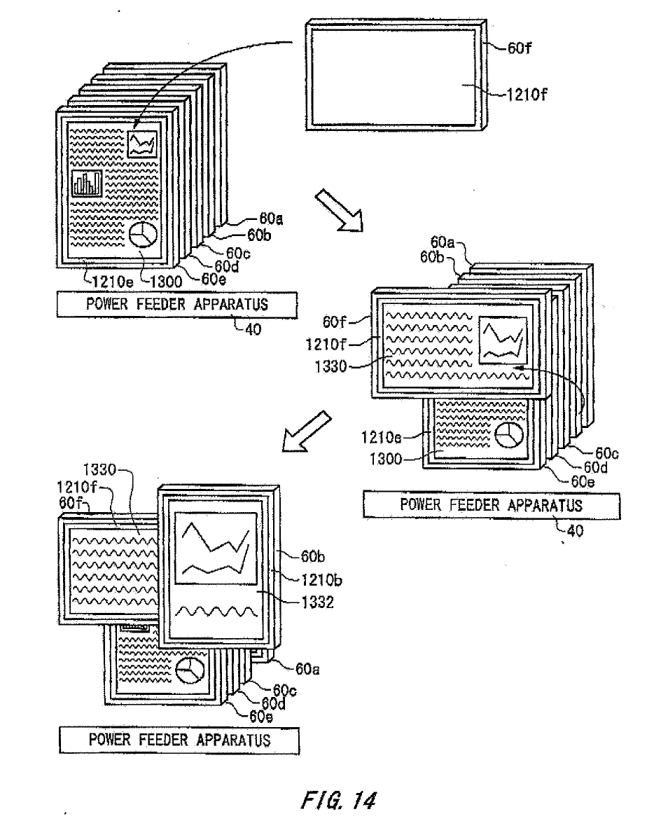

FIG. 14 shows another display example in the present display system. This display example corresponds to a case where display is performed to each display section 1210 after the electronic paper 60a—the electronic paper 60f have been placed, and then another display is performed to the display section 1210 of arbitrary electronic paper. The electronic paper 60a—the electronic paper 60e are placed over the power feeder apparatus 40, and the display section 1210e of the electronic paper 60e displays the display data 1300. On the other hand, the display section 1210f of the electronic paper 60f does not display anything. The electronic paper 60f is placed under this state.

The electronic paper 60f is placed to overlap on the electronic paper 60e, and in a different direction to the direction of the electronic paper 60e. In other words, the display section 1210e and the display section 1210f are in an overlapping relation and a different direction relation. By placing the electronic paper 60f, power is received from the power feeder apparatus 40, and each section starts operating so that the position determination section 1212f determines the positional relation and the display control section 1214f controls display of the display section 1210f, just as in the example described above.

By placing the electronic paper 60f in a different direction from the direction of the electronic paper 60e, the position determination section 1212f determines that the positional relation between the display section 1210e and the display section 1210f is a different direction relation. The display control section 1214f performs enlarged display of the partial data 1330 of the display data 1300 to the display section 1210f, based on the determination that the positional relation is a different direction relation. Note that the display data 1300 can be acquired from the electronic paper 60e or the information processing apparatus 30 via the communication section 1218f.

Next, for example the electronic paper 60b is held up, and the electronic paper 60b is overlapped to the display section 1210f of the electronic paper 60f again, or placed in a different direction to the direction of the display section 1210f. By being held up, the electronic paper 60b is cut off from power, and power feeding restarts thereto by being set in place again. At this time, the electronic paper 60b detects the power feeding restart, and generates a display activation signal to activate display processing.

That is, the same processing as the reset operation is performed. As a result, the position determination section 1212b of the electronic paper 60b determines the positional relation between the display section 1210f and the display section 1210b. The display control section 1214b of the electronic paper 60b performs enlarged display of the partial data 1332 of the partial data 1330 to the display section 1210b of the electronic paper 60b, according to the determination that the positional relation is either the overlapping relation or the different direction relation. Note that the partial data 1330 can be acquired from the electronic paper 60f or the information processing apparatus 30 via the communication section 1218b.

According to the display system of the present example, it is possible to reset the once displayed electronic paper 60b, to perform redisplay. In doing so, it is possible to perform enlarged display of further partial data of the partial data 1330, by placing the electronic paper 60b to be overlapped on the partial data 1330 on display by the display section 1210f of the electronic paper 60f, or in a different direction thereto. By repeating such an operation, a user is able to view enlarged display data with ease. Note that the present example shows “the electronic paper 60b” as electronic paper for redisplay. However, other pieces of electronic paper may also be used for redisplay in the similar manner.

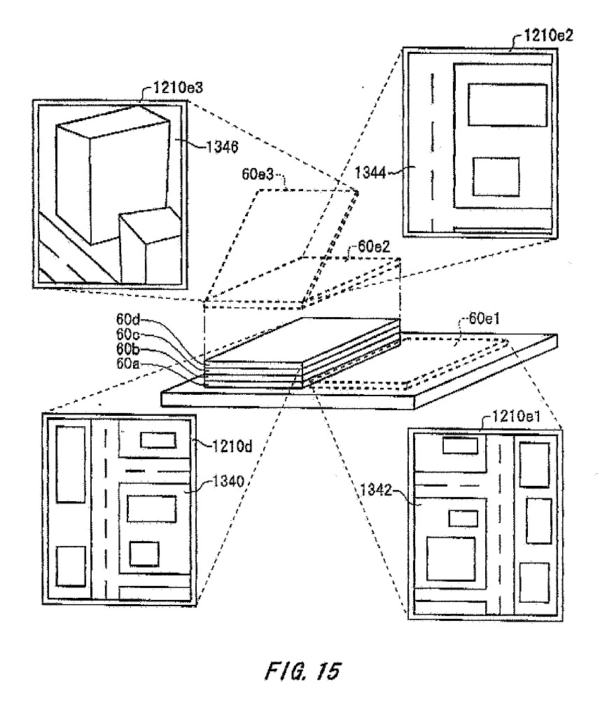

FIG. 15 shows another display example in the present display system. Here, the display example shows a display manner with respect to the display section 1210e when the electronic paper 60e is in a held-up relation with respect to the electronic paper 60a—the electronic paper 60d. The electronic paper 60a—the electronic paper 60d are placed to overlap to each other over the power feeder apparatus 40. Map data 1340 is displayed to the display section 1210d of the electronic paper 60d as display date The electronic paper 60e is placed under this state.

By placing he electronic paper 60e, power is received from the power feeder apparatus 40, and each section starts operating so that the position determination section 1212e determines the positional relation and the display control section 1214e controls display of the display section 1210e, just as in the example described above. However, the present example is different in that the electronic paper 60e is in a held-up relation with respect to the electronic paper 60d in which it is held up from the display surface of the electronic paper 60d, in addition to being placed adjacent to the electronic paper 60d, and that the electronic paper 60e is in a tilted positional relation with respect to the electronic paper 60d in the held-up relation.

First, when placing the electronic paper 60e adjacent to the electronic paper 60d (in is case, the electronic paper is indicated as 60e1, and the display section is indicated as 1210e1), the position determination section 1212e determines that the positional relation between the display section 1210d and the display section 1210e is an adjacent relation. The display control section 1214e displays map data 1342, being adjacent data with respect to the map data 1320, to the display section 1210e1, based on the determination that the positional relation is the adjacent relation. Note that the map data 1342 can be acquired from the electronic paper 60d or the information processing apparatus 30 via the communication section 1218e.

Next when holding up the electronic paper 60e from the display surface of the electronic paper 60d (in this case, the electronic paper is indicated as 60e2, and the display section is indicated as 1210e2), the position determination section 1212e determines that the positional relation between the display section 1210d and the display section 1210e is a held-up relation. The display control section 1214e displays an enlarged view 1344 of the map data 1340, being partial data of the map data 1340, to the display section 1210e2, based on the determination that the positional relation is the held-up relation.

The enlargement ratio of the enlarged view 1344 can be determined according to the distance between the display section 1210d and the display section 1210e. For example, when the distance is long, the enlargement ratio a be set larger, while the distance is short, the enlargement ratio may be set smaller. In addition, the enlargement ratio may be set as smaller than 1 (i.e. reduced display). Note that the map data 1340 can be acquired from the electronic paper 60d or the information processing apparatus 30 via the communication section 1218e, and the enlarged view 1344 can be appropriately calculated from the map data 1340.

Furthermore, in the held-up relation described above, the electronic paper 60e may be tilted with respect to the electronic paper 60d (in this case, the electronic paper is indicated as 60e3, and the display section is indicated as 1210e3). The display to the display section 1210e is controllable depending on the angle of the tilting. In other words, the position determination section 1212e may determine the angle formed between the plane to which die display section 1210d belongs and the plane to which the display section 1210e belongs, as a positional relation.

According to the angle, the display control section 1214e changes the direction of the line of vision or the rotation angle in case when the enlarged view 1344, being partial data of the map data 1340, is displayed as a stereoscopic image, and displays a map image 1346 resulting after changing the direction of the line of vision or the rotation angle, to the display section 1210e3. Note that the map data 1340 can be acquired from the electronic paper 60d or the information processing apparatus 30 via the communication section 1218e.

According to the display system of the present example it is possible to perform enlarged display of the map data 1340 on display by the display section 1210d, or to display the map data 1340 after changing its direction of the line of vision or the rotation angle, based on the determination that the positional relation between the display section 1210d and the display section 1210e is the held-up relation, or that the display section 1210e is tilted with respect to the display section 1210d in the held-up relation. As a consequence, a user is able to view a map image in stereoscopic display using the enlargement ratio or in the direction of the line of vision that are appropriate, by simply holding up or tilting the electronic paper 60e. Note that although the present example shows map data, the display system of the present example is also applicable to a stereoscopic image.

According to the display system shown in these examples, an adjacent document page can be displayed, or enlarged or reduced display of document data or its partial data can be performed, by adding new electronic paper 60 to the plurality of pieces of electronic paper 60 of which the display sections 1210 display display data or the like. By adding new electronic paper 60, a user is able to sequentially display adjacent pages, to display an enlarged page of the already displayed page, or to display a reduced page of the already displayed page to one display section 1210.

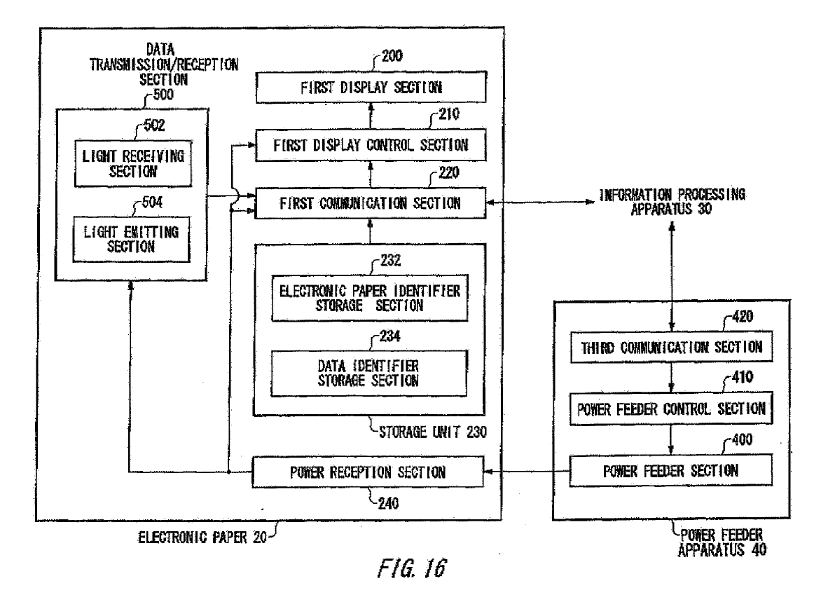

FIG. 16 shows another example of a functional configuration of the electronic paper 20 and the power feeder apparatus 40. The electronic paper 20 in FIG. 16 may be the same as the electronic paper 20 in FIG. 2, except for the configuration of the data transmission/reception section 500. In addition, the power feeder apparatus 40 may also be the same as the power feeder apparatus 40 in FIG. 2.

The electronic paper 20 shown in FIG. 16 includes a data transmission/reception section 500, and the data transmission/reception section 500 includes a light receiving section 502 and a light emitting section 504. The data transmission/reception section 500 may be one example of a positional information detection section included in electronic paper 20. The light emitting section 504 emits communication light conveying identification information of itself, from the rear surface of the first display section 200. The light receiving section 502 receives communication light conveying identification information of other than itself, from the front surface of the first display section 200. Then the positional relation determination section 360 determines the mutual positional relation of a plurality of pieces of electronic paper from the identification information transmitted through the communication light received at light receiving sections 502 respectively included in the plurality of pieces of electronic paper.

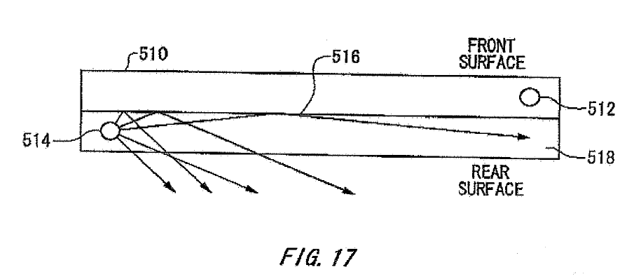

FIG. 17 shows a partial cross-sectional view of the electronic paper 20. The front surface member 510 of the first display section 200 includes a light receiving element 512, and the rear surface member 518 includes a light emitting element 514. A reflective plate 516 is placed between the front surface member 510 and the rear surface member 518. The light receiving element 512 and the light emitting element 514 may be a photodiode or a light-emitting diode, for example, and may be a concrete example of the light receiving section 502 and of the light emitting section 504.

The front surface member 510 may be a transparent resin or the like, and transmits light incident to the light receiving element 512 provided at a side of the front surface member 510. The rear surface member 518 may be a transparent resin or the like, as the front surface member 510, except that rear surface member 518 is desirably equipped with a diffusing function or a light guide function for diffusing the light from the light emitting element 514 throughout the entire rear surface.

The reflective plate 516 reflects the light emitted from the light emitting element 514 in the rear-surface direction. That is, since there is the reflective plate 516, the light emitted from the light emitting element 514 will be directed toward the rear-surface direction instead of being directed to the front-surface direction. In addition, the light receiving element 512 will not receive light from the rear surface, but receives light coming from the front-surface direction instead.

That is, the light emitting section 504 is able to emit, from the rear surface of the display section, communication light conveying identification information of electronic paper that is positioned above itself and is recognized by itself, in addition to the identification information of itself. Therefore, the light emitting section 504 is able to convey, to electronic paper positioned below itself, the identification information of electronic paper positioned above itself as well as the identification information of itself. In addition, the light receiving section 502 is able to receive, from electronic paper positioned above itself, the identification information of the electronic paper and identification information of electronic paper that is positioned further above and is recognized by the electronic paper. The positional relation determination section 360 determines a mutual overlapping position among a plurality of pieces of electronic paper, from the identification information of electronic paper positioned above itself and is conveyed through the communication light received by the light receiving section 502 included each of in the plurality of pieces of electronic paper.

By having a data transmission/reception section 500 transmitting and receiving communication light including the above-described identification information, it is possible to determine the mutual overlapping position of pieces of electronic paper 20. The data transmission section 380 may transmit data to be displayed by each piece of electronic paper, to the piece of electronic paper, according to the overlapping position thus determined, as in the similar manner as described above.

In addition, also in the similar manner as described above, when pieces of electronic paper respectively including a data transmission/reception section 500 are distanced away from each other after their display sections are caused to display data, the display at the display sections may be retainable. Furthermore, from the determination of the overlapping position described above, it is possible to determine that electronic paper is in a position visible to a user, from the above-described overlapping position determination. Concretely, this corresponds to a case where no such communication light has been received, or where it is impossible to distinguish identification information of electronic paper positioned above itself. In this case, such electronic paper is able to be determined to be on the uppermost position of the overlapping, i.e. in a position visible to a user. In addition, also in the similar manner as described above, display data of electronic paper in a position visible to a user may be editable.

In addition, also in the similar manner as described above, transmission of display data to the display section may be performed so as to correspond to the order of overlapping in accordance with the overlapping relation determined with use of the above-mentioned communication light. Also in the similar manner as described above, power may be selectively fed to electronic paper visible to a user, in accordance with the determination of the overlapping position.

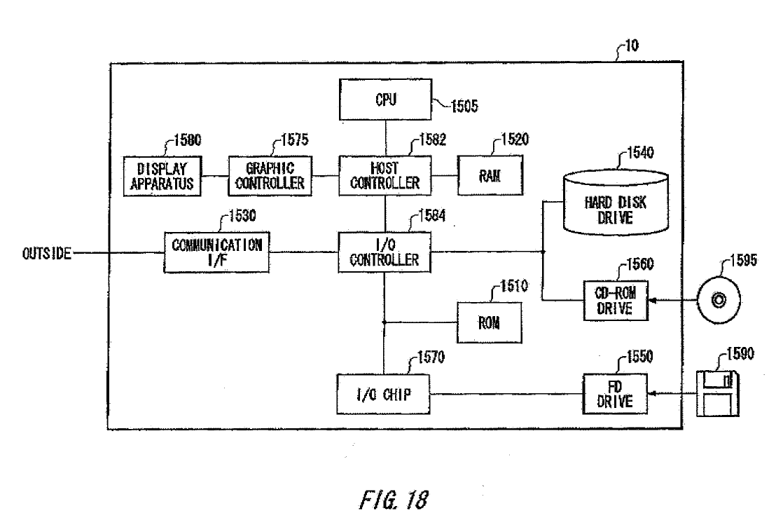

FIG. 18 shows one example of a hardware configuration of the display system 10 according to the present embodiment. The display system 10 according to the present embodiment includes a CPU periphery having a CPU 1505, a RAM 1520, a graphic controller 1575 and a display apparatus 1580 which are connected through a host controller 1582 each other, an input/output device having a communication interface 1530, a hard disk drive 1540 and a CD-ROM drive 1560 which are connected to the host controller 1582 through an input/output controller 1584 and a legacy input/output device having a ROM 1510, a flexible disk drive 1550 and an input/output chip 1570 which are connected to the input/output controller 1584.

The host controller 1582 connects the RAM 1520 to the CPU 1505 and the graphic controller 1575 which access the RAM 1520 with a high transfer rate. The CPU 1505 operates according to the programs stored in the ROM 1510 and the RAM 1520 to control each unit. The graphic controller 1575 acquires image data generated on a frame buffer provided in the RAM 1520 by the CPU 1505 or the like and displays the same on the display 1580. Alternatively, the graphic controller 1575 may include therein a frame buffer for storing image data generated by the CPU 1505 or the like.

The input/output controller 1584 connects the host controller 1582 to the communication interface 1530, the hard disk drive 1540 and the CD-ROM drive 1560 which are relatively high-speed input/output devices. The communication interface 1530 communicates with the other device through a network. The hard disk drive 1540 stores the program and data used by the CPU 1505 in the display system 10 and the display system 12. The CD-ROM drive 1560 reads the program or data from the CD-ROM 1595 and provides the same to the hard disk drive 1540 through the RAM 1520.

The ROM 1510, and the flexible disk drive 1550 and input/output chip 1570 which are relatively low-speed input/output devices are connected to the input/output controller 1584. The ROM 1510 stores a boot program executed by the display system 10 and the display system 12 at activating the display system 10 and e display system 12 and a program depending on the hardware of the display system 10 and the display system 12. The flexible disk drive 1550 reads the programs or data from a flexible disk 1590 and provides the same to the hard disk drive 1540 through the RAM 1520. The input/output chip 1570 connects various input/output devices trough the flexible disk drive 1550 such as a parallel port, a serial port, a keyboard port and a mouse port.

A display program provided to the hard disk drive 1540 trough the RAM 1520 is in a recording medium, such as the flexible disk 1590, the CD-ROM 1595, an IC card or the like, and provided by the user. The display program is read from the recording medium, installed to the hard disk drive 1540 within the display system 10 via the RAM 1520, and is executed in the CPU 1505. The display program executed after being installed in the display system 10 acts onto the CPU 1505 and the like, to cause the display system 10 to function as the first display section 200, the first display control section 210, the first communication section 220, the storage unit 230, the electronic paper identifier storage section 232, the data identifier storage section 234, the power reception section 240, the light quantity detection section 250, the light sensor 252, the second display section 300, the second display control section 310, the second communication section 320, the position identifying section 330, the data acquiring section 340, the data editing control section 350, the positional relation determination section 360, the editing instruction acquiring section 370, the information inputting section 374, the data transmission section 380, the data storage section 390, the display order storage section 392, the power feeder section 400, the power feeder control section 410, and the third communication section 420, which are explained through FIG. 1 to FIG. 6.

In the above, some aspects of the present invention have been described by way of exemplary embodiments. However, it is needless to say that the technical scope of the present invention should not be limited by the above-described embodiments. It should be understood at those skilled in the art might make various types of modifications and substitutions to the above-described embodiments without departing from the spirit and the scope of the present invention. It is obvious from the appended claims that embodiments with such modifications or substitutions also belong to the technical scope of the present invention.

What is claimed is:

1. A display system comprising:
a plurality of pieces of electronic paper, each of which includes a display section that displays data and a positional information detection section that detects positional information for determining a positional relation;
a positional relation determination section that determines a mutual positional relation of the plurality of pieces of electronic paper, from the positional information detected by the positional information detection section included in each of the plurality of pieces of electronic paper; and
a data transmission section that transmits data to be displayed to the display section included in each of the plurality of pieces of electronic paper, to each of the plurality of pieces of electronic paper, in accordance with the mutual positional relation of the plurality of pieces of electronic paper determined by the positional relation determination section.

2. The display system as set forth in claim 1, wherein
the positional information detection section includes an electromagnetic wave strength detection section that detects a strength of an irradiated electromagnetic wave, and
the positional relation determination section determines the mutual positional relation of the plurality of pieces of electronic paper, from the strength detected by the electromagnetic wave strength detection section included in each of the plurality of pieces of electronic paper.

3. The display system as set forth in claim 2, wherein
the positional relation determination section determines that the plurality of pieces of electronic paper are overlapped to each other, in an order of the strength detected by the electromagnetic wave strength detection section included in each of the plurality of pieces of electronic paper, and
the data transmission section transmits, to each of the plurality of pieces of electronic paper, data to be displayed to the display section included in each of the plurality of pieces of electronic paper, in an order in which the plurality of pieces of electronic paper are overlapped which is determined by the positional relation determination section.

4. The display system as set forth in claim 3, wherein
when each of the plurality of pieces of electronic paper is placed to be apart from each other after the data transmission section has transmitted the data to be displayed to the display section included in each of the plurality of pieces of electronic paper, the display system retains display to the display section of each of the plurality of pieces of electronic paper.

5. The display system as set forth in claim 2, wherein
the positional relation determination section determines that the electronic paper including the electromagnetic wave strength detection section having detected a predetermined strength or more exists in a position visible to a user, and
the data transmission section, to the electronic paper which the positional relation determination section has determined to exist in a position visible to the user, transmits the data to be displayed to the display section included in the electronic paper.

6. The display system as set forth in claim 2, wherein
the positional relation determination section determines that the electronic paper including the electromagnetic wave strength detection section having detected a predetermined strength or more exists in a position visible to a user, and
the display system further comprises:
a data editing control section that permits editing of contents of data on display by the display section included in the electronic paper which the positional relation determination section has determined to exist in a position visible to the user.

7. The display system as set forth in claim 2, wherein
the positional relation determination section determines that the electronic paper including the electromagnetic wave strength detection section having detected the largest strength exists in a position visible to a user, and
the data transmission section, to the electronic paper which the positional relation determination section has determined to exist in a position visible to the user, transmits the data to be displayed to the display section included in the electronic paper.

8. The display system as set forth in claim 2, wherein
the positional relation determination section determines that the electronic paper including the electromagnetic wave strength detection section having detected the largest strength exists in a position visible to a user, and
the display system further comprises:
a data editing control section that permits editing of contents of data on display by the display section included in the electronic paper which the positional relation determination section has determined to exist in a position visible to the user.

9. The display system as set forth in claim 2, wherein
the electronic paper further includes a data identifier storage section that stores a data identifier identifying data on display by the display section,
the display system further comprises
a display order storage section that stores, in association with each of a plurality of data identifiers, a display order of data identified by the data identifiers,
the positional relation determination section determines that the plurality of pieces of electronic paper are overlapped to each other, in an order of the strength detected by the electromagnetic wave strength detection section included in each of the plurality of pieces of electronic paper, and
the data transmission section transmits each data identified by a data identifier stored in any of a plurality of the data identifier storage section, to each of the plurality of pieces of electronic paper, so as to match the display order of data stored in the display order storage section and the order in which the plurality of pieces of electronic paper are overlapped to each other determined by the positional relation determination section.

10. The display system as set forth in claim 2, wherein
the electromagnetic wave strength detection section includes a plurality of electromagnetic wave detection sensors respectively placed at a plurality of predetermined positions of the electronic paper, and
the positional relation determination section determines the mutual positional relation of the plurality of pieces of electronic paper, from strengths of electromagnetic waves respectively detected by the plurality of electromagnetic wave detection sensors included in each of the plurality of pieces of electronic paper.

11. The display system as set forth in claim 10, wherein
the plurality of electromagnetic wave detection sensors are placed in respective vicinities of a plurality of sides or a plurality of corners of the electronic paper.

12. The display system as set forth in claim 10, wherein
the positional relation determination section determines that the plurality of pieces of electronic paper are overlapped to each other, in an order from electronic paper having more electromagnetic detection sensors in number having detected a electromagnetic wave strength of a predetermined value or more, from among the plurality of electromagnetic wave detection sensors included in each of the plurality of pieces of electronic paper.

13. The display system as set forth in claim 2, further comprising:
a power feeder apparatus that feeds power to the electronic paper by generating a magnetic field in a predetermined range, wherein
the electronic paper further includes a power reception section that receives power from the magnetic field generated by the power feeder apparatus, and
when the power reception section has received power, the electromagnetic wave strength detection section detects the strength of the magnetic wave using the received power.

14. The display system as set forth in claim 13, wherein
the positional relation determination section determines that the electronic paper including the electromagnetic wave strength detection section having detected a predetermined strength or more exists in a position visible to a user,
the display system further comprises:
a position identifying section that identifies a position of the electronic paper which the positional relation determination section has determined to exist in a position visible to the user, and
the power feeder apparatus includes:
a plurality of power feeder sections placed in a predetermined interval therebetween in a range where the electronic paper is to be positioned; and
a power feeder control section that generates a magnetic field to power feeder sections positioned in the position identified by the position identifying section and causes to feed power to the electronic paper which the positional relation determination section has determined to exist in a position visible to a user.

15. The display system as set forth in claim 13, wherein
the positional relation determination section determines that the electronic paper including the electromagnetic wave strength detection section having detected the largest strength exists in a position visible to a user,
the display system further comprises
a position identifying section that identifies a position of the electronic paper which the positional relation determination section has determined to exist in a position visible to the user, and
the power feeder apparatus includes:
a plurality of power feeder sections placed in a predetermined interval therebetween in a range where the electronic paper is to be positioned; and
a power feeder control section that generates a magnetic field to power feeder sections positioned in the position identified by the position identifying section and causes to feed power to the electronic paper which the positional relation determination section has determined to exist in a position visible to a user.

16. The display system as set forth in claim 1, wherein
the positional information detection section includes a light emitting section that emits communication light conveying identification information of itself, from a rear surface of the display section, and a light receiving section that receives communication light conveying identification information of other than itself, from a front surface of the display section, and
the positional relation determination section determines a mutual positional relation of the plurality of pieces of electronic paper, from the identification information conveyed through the communication light received by the light receiving section included in each of the plurality of pieces of electronic paper.

17. The display system as set forth in claim 16, wherein
the light emitting section emits, from the rear surface of the display section, communication light conveying identification information of electronic paper positioned above itself and is recognized by itself, in addition to the identification information of itself,
the positional relation determination section determines a mutual overlapping position among the plurality of pieces of electronic paper, from the identification information of electronic paper positioned above itself and is conveyed through the communication light received by the light receiving section included in each of the plurality of pieces of electronic paper, and
the data transmission section transmits data to be displayed to the display section included in each of the plurality of pieces of electronic paper, to each of the plurality of pieces of electronic paper, in an order of the overlapping position among the plurality of pieces of electronic paper determined by the positional relation determination section.

18. The display system as set forth in claim 17, wherein
when each of the plurality of pieces of electronic paper is placed to be apart from each other after the data transmission section has transmitted the data to be displayed to the display section included in each of the plurality of pieces of electronic paper, the display system retains display to the display section of each of the plurality of pieces of electronic paper.

19. The display system as set forth in claim 16, wherein
when the light receiving section has not received the communication light, or when the identification information of electronic paper positioned above itself that is conveyed through the communication light received by the light receiving section has not been distinguishable, the positional relation determination section determines that the electronic paper including the light receiving section exists in a position visible to the user, and
the data transmission section, to the electronic paper which the positional relation determination section has determined to exist in a position visible to the user, transmits the data to be displayed to the display section included in the electronic paper.

20. The display system as set forth in claim 16, wherein
when the light receiving section has not received the communication light, or when the identification information of electronic paper positioned above itself that is conveyed through the communication light received by the light receiving section has not been distinguishable, the positional relation determination section determines that the electronic paper including the light receiving section exists in a position visible to the user, and
the display system further comprises:
a data editing control section that permits editing of contents of data on display by the display section included in the electronic paper which the positional relation determination section has determined to exist in a position visible to the user.

21. The display system as set forth in claim 16, wherein
the electronic paper further includes a data identifier storage section that stores a data identifier identifying data on display by the display section,
the display system further comprises
a display order storage section that stores, in association with each of a plurality of data identifiers, a display order of data identified by the data identifiers,
the positional relation determination section determines a mutual overlapping position among the plurality of pieces of electronic paper, from the identification information of electronic paper positioned above itself and is conveyed through the communication light received by the light receiving section included in each of the plurality of pieces of electronic paper, and
the data transmission section transmits each data identified by a data identifier stored in any of a plurality of the data identifier storage section, to each of the plurality of pieces of electronic paper, so as to match the display order of data stored in the display order storage section and the order in which the plurality of pieces of electronic paper are overlapped to each other determined by the positional relation determination section.

22. The display system as set forth in claim 16, further comprising:
a power feeder apparatus that feeds power to the electronic paper by generating a magnetic field in a predetermined range, wherein
the electronic paper further includes a power reception section that receives power from the magnetic field generated by the power feeder apparatus, and
when the power reception section has received power, the light emitting section emits the communication light and the light receiving section receives the communication light using the received power.

23. The display system as set forth in claim 22, wherein
when the light receiving section has not received the communication light, or when the identification information of electronic paper positioned above itself that is conveyed through the communication light received by the light receiving section has not been distinguishable, the positional relation determination section determines that the electronic paper including the light receiving section exists in a position visible to the user,
the display system further comprises:
a position identifying section that identifies a position of the electronic paper which the positional relation determination section has determined to exist in a position visible to the user, and
the power feeder apparatus includes:
a plurality of power feeder sections placed in a predetermined interval therebetween in a range where the electronic paper is to be positioned; and
a power feeder control section that generates a magnetic field to power feeder sections positioned in the position identified by the position identifying section and causes to feed power to the electronic paper which the positional relation determination section has determined to exist in a position visible to a user.

24. A display method comprising:
a displaying step of displaying each data by a display section included in each of a plurality of pieces of electronic paper;
a positional information detecting step of detecting positional information by a positional information detection section included in each of the plurality of pieces of electronic paper;
a positional relation determining step of determining a mutual positional relation of the plurality of pieces of electronic paper, from the positional information detected for each of the plurality of pieces of electronic paper in the positional information detecting step; and
a data transmitting step of transmitting data to be displayed to the display section included in each of the plurality of pieces of electronic paper, to each of the plurality of pieces of electronic paper, in accordance with the mutual positional relation of the plurality of pieces of electronic paper determined in the positional relation determining step.

25. A display program for a display system that includes a plurality of pieces of electronic paper that displays data, the display program causing the display system to function as:
a positional information detection selection that detects positional information and is included in each of the plurality of pieces of electronic paper;
a positional relation determination section that determines a mutual positional relation of the plurality of pieces of electronic paper, from the positional information detected by the positional information detection section included in each of the plurality of pieces of electronic paper; and
a data transmission section that transmits data to be displayed to the display section included in each of the plurality of pieces of electronic paper, to each of the plurality of pieces of electronic paper, in accordance with the mutual positional relation of the plurality of pieces of electronic paper determined by the positional relation determination section.
